(19) United States
(12) Patent Application Publication
(10) Pub. No.: US 2015/0003528 A1
(43) Pub. Date: Jan. 1, 2015

(54) IMAGE PROCESSING APPARATUS AND IMAGE PROCESSING METHOD

(71) Applicant: FUJITSU LIMITED, Kawasaki-shi (JP)

(72) Inventor: Masahiko Toichi, Urayasu (JP)

(21) Appl. No.: 14/313,279

(22) Filed: Jun. 24, 2014

(30) Foreign Application Priority Data
Jul. 1, 2013 (JP) 2013-138457

(51) Int. Cl. H04N 19/51; H04N 19/583

(52) U.S. Cl. CPC H04N 19/00703; H04N 19/00733
USPC 375/240.14

(57) ABSTRACT

An image processing apparatus includes: a memory; and a processor coupled to the memory and configured to: detect, based on a reduced image of a target frame and a reduced image of a reference frame, a first motion vector of a target block divided from the target frame, set a search range including a pixel row in the target frame and parallel to the pixel row corresponding to a first pixel component that is specified by the first motion vector and substantially perpendicular to an edge direction of a block in the reference frame, calculate, for each of second pixel components corresponding to the first pixel component in the search range, an evaluation value representing a difference of a pixel value between the first pixel component and the second pixel component, and correct the first motion vector based on the evaluation value of each of the second pixel components.

### CROSS-REFERENCE TO RELATED APPLICATION

This application is based upon and claims the benefit of priority from the prior Japanese Patent Application No. 2013-138457 filed on Jul. 1, 2013, the entire contents of which are incorporated herein by reference.

### FIELD

The embodiments discussed herein are related to an image processing apparatus, and an image processing method for correction.

### BACKGROUND

Motion estimation is a process of searching a reference frame for a block similar to an original block in a target frame which is a processing target among a series of frames and outputting the difference from the original block in the spatial position as a motion vector. In addition, there is a technique called hierarchical motion estimation in which motion estimation is performed on a subsampled reduced image.

In the hierarchical motion estimation, for example, an approximate motion vector is derived in motion estimation of the first stage by using images respectively reduced from the original image and the reference image. In motion estimation of the second stage, by using the original image and the reference image, motion search is performed on a search range in which a point indicated by the motion vector as the result of the motion estimation of the first stage is the center.

For example, in a case where the motion vector is derived in the motion estimation of the first stage by using the image which is reduced to ½ in the vertical and horizontal directions compared to the original image, when the derived motion vector is enlarged twice in the vertical and horizontal directions to be applied to the original image, it can be said that the motion vector in units of 2 pixels is obtained. In the motion search of the second stage, the motion vector having the pixel accuracy of the original image can be obtained by searching for motion estimation vectors at search points in a range of ±1 in the vertical and horizontal directions, that is, 3×3. By performing the hierarchical motion estimation using the reduced image, the motion estimation can be performed with a smaller operation amount than motion estimation using the original image (for example, Japanese Laid-open Patent Publication No. 2009-55410).

In addition, since information having high frequency components of the image is lost due to the reduction process, and there is a possibility that the motion vector may be erroneously detected during the search using the reduced image. Therefore, there is a technique which does not perform hierarchical motion estimation in a case where the sharpness of an image is used as an evaluation value and the sharpness is high (for example, Japanese Laid-open Patent Publication No. 2012-19465).

### SUMMARY

According to an aspect of the invention, an image processing apparatus includes: a memory; and a processor coupled to the memory and configured to: detect, based on a reduced image of a target frame and a reduced image of a reference frame, a first motion vector of a target block divided from the target frame, set a search range including a pixel row in the target frame and parallel to the pixel row corresponding to a first pixel component that is specified by the first motion vector and substantially perpendicular to an edge direction of a block in the reference frame, calculate, for each of second pixel components corresponding to the first pixel component in the search range, an evaluation value representing a difference of a pixel value between the first pixel component and the second pixel component, and correct the first motion vector based on the evaluation value of each of the second pixel components.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory view illustrating an example of a correction method according to an embodiment.

FIG. 2 is an explanatory view illustrating the relationship between a motion vector and a search range.

FIG. 3 is a block diagram illustrating an example of the hardware configuration of a computer system.

FIG. 4 is an explanatory view illustrating a specific example of an edge perpendicular component of a block.

FIG. 5 is an explanatory view illustrating an example of the data structure of edge information.

FIG. 6 is an explanatory view illustrating an example of the stored contents of an edge information table.

FIG. 7 is a block diagram illustrating an example of the functional configuration of an image processing apparatus.

FIG. 8 is an explanatory view illustrating examples of setting a search range.

FIG. 9 is an explanatory view illustrating an example of a case where a pixel component corresponding to an edge perpendicular component deviates from a target block.

FIG. 10 is an explanatory view illustrating a first example of countermeasure against the case where the pixel component corresponding to the edge perpendicular component deviates from the target block.

FIG. 11 is an explanatory view illustrating a second example of the countermeasure against the case where the pixel component corresponding to the edge perpendicular component deviates from the target block.

FIG. 12 is an explanatory view illustrating a third example of the countermeasure against the case where the pixel component corresponding to the edge perpendicular component deviates from the target block.

FIG. 13 is an explanatory view illustrating a variation on the edge perpendicular component (1 thereof).

FIG. 14 is an explanatory view illustrating a variation on the edge perpendicular component (2 thereof).

FIG. 15 is a flowchart illustrating an example of an image processing procedure of the image processing apparatus.

FIG. 16 is a flowchart illustrating an example of a specific processing procedure of an edge information generating process.

FIG. 17 is a flowchart illustrating an example of a specific processing procedure of a first motion vector correcting process.

FIG. 18 is a flowchart illustrating an example of a specific processing procedure of a second motion vector detecting process.

FIG. 19 is a flowchart illustrating an example of the configuration of an encoding apparatus.

FIG. 20 is an explanatory view illustrating a specific example of transmission information.

### DESCRIPTION OF EMBODIMENTS

Hereinafter, embodiments of an image processing apparatus, an image processing method (a correction method), and a correction program will be described in detail with reference to the drawings.

While inventing the present embodiments, observations were made regarding a related art. Such observations include the following, for example.

According to the related art, in the hierarchical motion estimation, there are problems in that when the reduction ratio of an image is increased, the accuracy of a motion vector obtained in the motion estimation of the first stage is reduced, and thus the number of search points in the motion estimation of the second stage is increased, resulting in an increase in the amount of operation for the motion estimation.

According to an aspect, an object of the embodiment is to provide an image processing apparatus, a correction method, and a correction program capable of suppressing an increase in the amount of operation for the hierarchical motion estimation.

(Example of Correction Method)

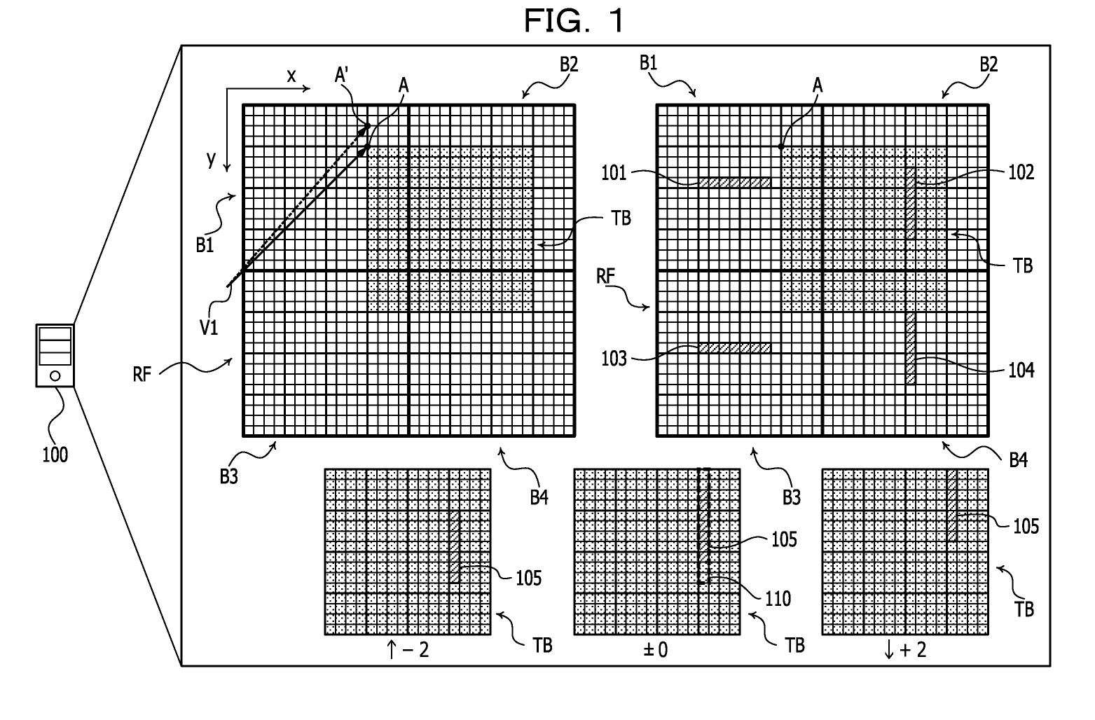

FIG. 1 is an explanatory view illustrating an example of the correction method according to the embodiment. In FIG. 1, the image processing apparatus 100 is a computer which performs the hierarchical motion estimation. The image processing apparatus 100 performs motion estimation according to a compression method determined by the standard such as moving picture experts group (MPEG) 2, MPEG4, H.264, and high efficiency video coding (HEVC).

Here, the motion estimation is a process of searching a reference image for a block similar to a block that is partitioned and divided from a target image and outputting the difference between the spatial positions of the blocks as a motion vector. The target image is an image of a target frame which is a processing target (for example, encoding target) among a series of frames as a moving image. The target image may be the original image of the target frame, or may be an image reduced from the original image of the target frame.

The reference image is an image of a reference frame which is a reference destination of the target frame among the series of frames. The reference image is, for example, an encoded image. The block is an image that is partitioned and divided from the target image or the reference image in units of, for example, 8×8 pixels or 16×16 pixels. In the target image, the block is a unit for performing estimation between the frames, such as a so-called macroblock or block partition.

Further, hierarchical motion estimation is a method of dividing the entire process of motion estimation into a plurality of stages, performing the motion estimation in a previous stage on images reduced from the original image and the reference image, and performing the motion estimation in the second and further stages on a search range of the reference image specified from the motion vector that is detected in the previous stage.

Specifically, for example, in the motion estimation of the first stage, the image processing apparatus 100 detects the motion vector of the target block divided from the target frame based on a reduced image that is reduced from the target frame and a reduced image that is reduced from the reference frame at a reduction ratio r (rₓ×r_{y}). Here, rₓ is the reduction ratio in the x-axis direction, r_{y} is the reduction ratio in the y-axis direction, and both are values smaller than 1.

More specifically, for example, the image processing apparatus 100 calculates an evaluation value which represents the difference between a reference block and the target block corresponding to a candidate vector for each of candidate vectors which are candidates for the motion vector. The image processing apparatus 100 outputs, for example, the candidate vector having the smallest calculated evaluation value as the motion vector. Accordingly, an approximate motion vector may be derived using the reduced images respectively reduced from the target frame and the reference frame.

In the following description, there may be cases where the motion estimation of the first stage is referred to as “reduced motion estimation (ME)”, and the motion vector detected in the reduced ME is referred to as a “first motion vector”. In addition, there may be cases where the motion estimation of the second stage is referred to as “detailed ME”, and the motion vector detected in the detailed ME is referred to as a “second motion vector”.

Next, in the detailed ME, using the target frame and the reference frame, the image processing apparatus 100 searches, as the search range, the vicinity of a point in the reference frame specified by the first motion vector that is the result of the reduced ME, for the second motion vector. The search start point of the detailed ME is a point in the reference frame indicated by a vector obtained by enlarged the first motion vector by the reciprocal (1/r) of the reduction ratio r.

In the following description, there may be a case where the vector obtained by enlarging the first motion vector by the reciprocal (1/r) of the reduction ratio r is referred to as the “first motion vector”.

In the reduced ME, as the reduction ratio is increased, the larger range can be searched with a smaller operation amount. However, as the reduction ratio is increased, the accuracy of the first motion vector obtained in the reduced ME is reduced (that is, the interval between the points indicated by the motion vectors is increased). Therefore, in the detailed ME, the number of search points for performing motion estimation with high accuracy in units of pixels is increased, resulting in an increase in the amount of calculation for the motion estimation.

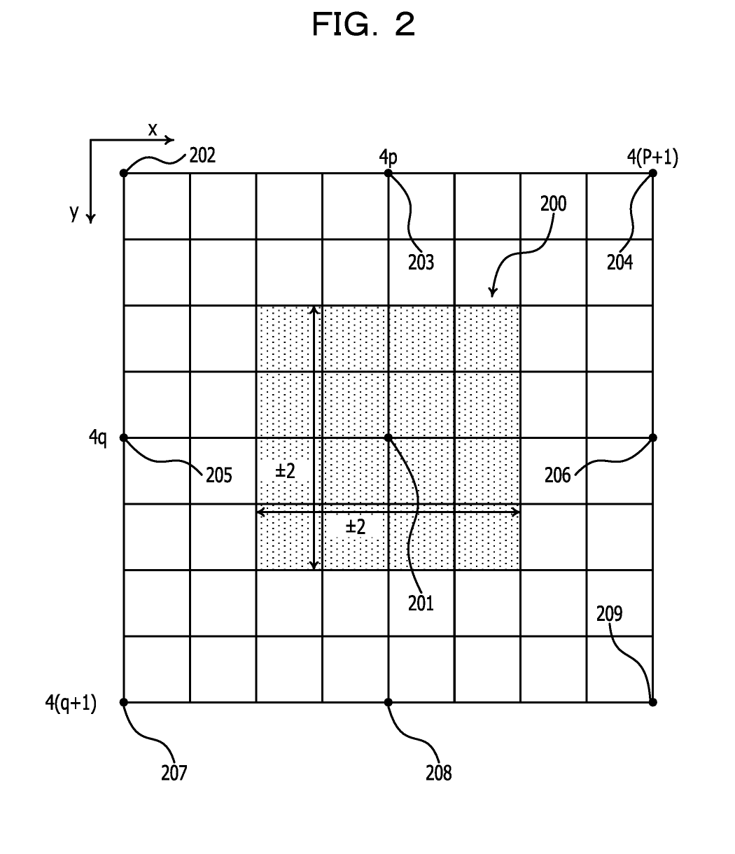

With reference to FIG. 2, the relationship between the first motion vector obtained in the reduced ME and the search range in the detailed ME will be described. It is postulated that the first motion vector is detected using the reduced images reduced from the target frame and the reference frame at a reduction ratio of “¼ (¼×¼)”.

FIG. 2 is an explanatory view illustrating the relationship between the motion vector and the search range. In FIG. 2, lattice points 201 to 209 on a thick-line frame are points in the reference frame indicated by the first motion vectors obtained in the reduced ME. In addition, the search range 200 is an example of a search range in the detailed ME, which is set in a case where the point indicated by the first motion vector is the point 201.

Specifically, the lattice points 201 to 209 are provided in units of 4 pixels corresponding to the reciprocal of the reduction ratio “¼” respectively in the x-axis direction and the y-axis direction. In this case, in order to cover the search for integer pixel positions, in the detailed ME, the search is performed on a range of ±2 pixels in the x direction and the y direction at the minimum from the point 201 indicated by the first motion vector as the center.

Therefore, the search range 200 in the detailed ME is set to a range of, for example, ±2 pixels in the x-axis direction and ±2 pixels in the y-axis direction from the point 201 indicated by the first motion vector as the center. That is, as the reduction ratio is increased, the search is performed on a wider range in order to cover the search for the integer pixel positions in the reduced ME, resulting in an increase in the amount of calculation for the motion estimation. At this time, when the position indicated by the first motion vector obtained in the reduced ME can be obtained in a smaller unit than the reciprocal of the reduction ratio r, the search range of the detailed ME can be limited, thereby reducing the amount of operation for the motion estimation.

In this embodiment, the image processing apparatus 100 specifies a pixel component which is substantially perpendicular to the edge of a block in the reference frame from the first motion vector obtained in the reduced ME, and corrects the first motion vector by performing block matching between the specified pixel component and the target block. Hereinafter, an example of a correction process of the image processing apparatus 100 will be described.

(1) The image processing apparatus 100 detects a first motion vector V1 of a target block TB partitioned and divided from a target frame TF based on a reduced image reduced from the target frame TF and a reduced image reduced from a reference frame RF. Here, it is postulated that the first motion vector V1 is detected using the reduced images respectively reduced from the target frame TF and the reference frame RF at a reduction ratio of ¼ (¼×¼).

In the example of FIG. 1, a first motion vector V1 (4X, 4Y) of the target block TB is detected. Here, the first motion vector V1 is a vector obtained by enlarging the first motion vector V1 (X, Y) detected using the reduced images of the target frame TF and the reference frame RF by the reciprocal of the reduction ratio r, that is, 4 times.

(2) The image processing apparatus 100 specifies a first pixel component which is substantially perpendicular to the edge direction of the block B in the reference frame RF based on the detected first motion vector V1. The edge is a point where a change in brightness of an image is relatively large. Here, the edge is detected for each of the blocks B partitioned and divided from the reference frame RF.

The first pixel component is formed by one or more pixel rows which are substantially perpendicular to the edge direction. The length and the number of pixel rows forming the first pixel component may be arbitrary set. Further, the first pixel component may be formed by pixel rows which extend over a plurality of blocks B. In the example of FIG. 1, the first pixel component is formed by a pixel row having 7 pixels.

Specifically, for example, first, in a case where the target block TB is disposed at a point A in the reference frame RF indicated by the first motion vector V1, the image processing apparatus 100 specifies the blocks B in the reference frame RF that overlaps the target block TB. In the example of FIG. 1, blocks B1 to B4 in the reference frame RF are specified.

Next, the image processing apparatus 100 determines a degree of overlap between the pixel components 101 to 104 substantially perpendicular to the edge directions of the blocks B1 to B4 in the specified reference frame RF and the target block TB. The image processing apparatus 100 specifies the pixel component of the block B having the maximum degree of overlap with the target block TB as the first pixel component. In the example of FIG. 1, a pixel component 102 of the block B2 is specified as the first pixel component.

(3) The image processing apparatus 100 sets the search range which includes the pixel row in the target block TB corresponding to the specified first pixel component and is parallel to the pixel row. Specifically, for example, the image processing apparatus 100 sets the search range to a range in the target frame TF, which includes the pixel row in the target block TB corresponding to the first pixel component and in which the pixel row is shifted in parallel by ±k pixels.

Here, k is a value which is approximately ½ of the reciprocal of the reduction ratio r. For example, when the reduction ratio r is assumed to be “¼”, k is “2”. In the example of FIG. 1, the search range 110 is set to a range in which a pixel row 105 in the target frame TF corresponding to the first pixel component is shifted in the y-axis direction (the direction parallel to the pixel row 105) by ±2 pixels.

(4) In the set search range, the image processing apparatus 100 calculates an evaluation value which represents the difference between a pixel value of the first pixel component and a pixel value of the second pixel component for each of the second pixel components in the search range corresponding to the first pixel component. Here, the evaluation value is calculated, for example, by cumulatively adding values which represent the differences between the pixels corresponding to the first pixel component and the second pixel component.

The evaluation value acts as an index that determines a degree of similarity between the first pixel component and the second pixel component. A value which represents the difference between pixels is, for example, the absolute value of the difference between the pixel values of the pixels. The pixel value is color information indicated by a pixel, and for example, may be a component value such as a luminance component value, a blue color difference component value, and a red color difference component value or may be a component value such as a red component value, a green component value, or a blue component value.

Specifically, the evaluation value is, for example, the sum of absolute difference (SAD), the sum of absolute transformed difference (SATD), the sum of squared difference (SSD), or the like.

That is, the image processing apparatus 100 performs block matching between the first pixel component and the target block TB. Block matching is a search method of obtaining, as an evaluation value, the SSD or SAD between the pixel value in the target image and the pixel value that moves (vₓ, v_{y}) in the horizontal direction and the vertical direction with respect to the reference image and providing a movement amount representing the minimum evaluation value as the motion vector.

Here, the first pixel component is a pixel component which is substantially perpendicular to the edge direction of the block B in the reference frame RF. The pixel component which is substantially perpendicular to the edge direction has a tendency to significantly change the brightness. Therefore, in a case where block matching between the first pixel component and the pixel component in the target frame TF is performed, there is a high possibility that the evaluation value may significantly change, and a point in the target frame TF which is similar to the first pixel component may be efficiently searched.

In the example of FIG. 1, the second pixel component is obtained by shifting the pixel row 105 corresponding to the first pixel component of the reference frame RF in the y-axis direction by 1 pixel in the search range 110 in the target frame TF. That is, the second pixel component in the search range 110 has five patterns, and five patterns of the evaluation value which represents the difference between the pixel value of the first pixel component and the pixel value of the second pixel component are calculated.

Here, the evaluation value of a case (k=0) where the target block TB is not shifted in any of the positive direction and the negative direction of the y-axis, that is, a case where the pixel row 105 is the second pixel component is denoted by an “evaluation value v1”. In addition, the evaluation value of a case (k=1) where the target block TB is shifted in the positive direction of the y-axis by 1 pixel is denoted by an “evaluation value v2”.

In addition, the evaluation value of a case (k=2) where the target block TB is shifted in the positive direction of the y-axis by 2 pixels is denoted by an “evaluation value v3”. In addition, the evaluation value of a case (k=−1) where the target block TB is shifted in the negative direction of the y-axis by 1 pixel is denoted by an “evaluation value v4”. In addition, the evaluation value of a case (k=−2) where the target block TB is shifted in the negative direction of the y-axis by 2 pixels is denoted by an “evaluation value v5”.

(5) The image processing apparatus 100 corrects the first motion vector V1 based on the evaluation value of each of the calculated second pixel components. Specifically, for example, first, the image processing apparatus 100 specifies k corresponding to the minimum evaluation value v_min among the respective evaluation values v1 to v5 of the second pixel components. The image processing apparatus 100 corrects the first motion vector V1 by substituting the specified k by a correction amount k, for example, into the following expression (1) or (2).

V1(x,y)=V1(X/r+k,Y/r) (1)

V1(x,y)=V1(X/r,Y/r+k) (2)

More specifically, for example, in a case where the second pixel component is parallel to the x-axis, the image processing apparatus 100 corrects the first motion vector V1 by substituting the correction amount k into the above expression (1). Otherwise, in a case where the second pixel component is parallel to the y-axis, the image processing apparatus 100 corrects the first motion vector V1 by substituting the correction amount k into the above expression (2).

In the example of FIG. 1, when the evaluation value v3 among the evaluation values v1 to v5 is the minimum evaluation value v_min, the correction amount k is “k=2”. In addition, the second pixel component is parallel to the y-axis. Accordingly, the image processing apparatus 100 corrects the first motion vector V1 by substituting the correction amount k (k=2) into the above expression (2).

The first motion vector V1 after the correction is represented by the following expression (3). Specifically, the first motion vector V1 after the correction is a vector indicating a point A′ in the reference frame RF.

V1(X,Y)=V1(4X,4Y+2) (3)

As described above, the image processing apparatus 100 can correct the first motion vector V1 by performing block matching between the first pixel component of the block Bj in the reference frame RF specified from the first motion vector V1 obtained in the reduced ME, and the target block TB. Accordingly, the first motion vector V1 having a higher position accuracy than the reciprocal of the reduction ratio r can be efficiently obtained, and thus the search range in the detailed ME is limited, thereby reducing the amount of operation for the motion estimation.

(Example of Hardware Configuration of Computer System 300)

Next, an example of the hardware configuration of a computer system 300 to which the image processing apparatus 100 illustrated in FIG. 1 is applied will be described. The computer system 300 is, for example, a system having a function of recording and playing moving images, and specifically, for example, a personal computer, a television, a recorder, a video camera, a digital camera, a mobile phone, or a smart phone.

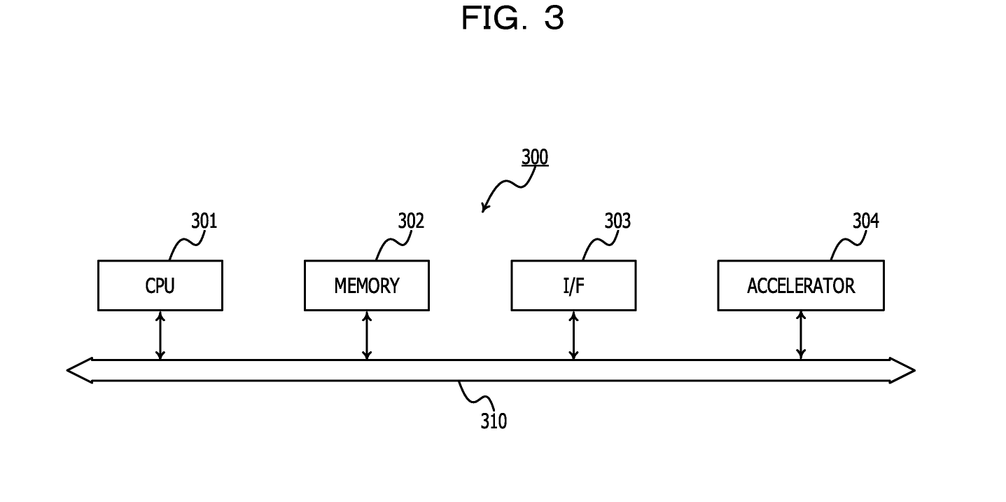

FIG. 3 is a block diagram illustrating the example of the hardware configuration of the computer system 300. In FIG. 3, the computer system 300 includes a central processing unit (CPU) 301, a memory 302, an interface (I/F) 303, and an accelerator 304. The units in the configuration are connected to each other via a bus 310.

Here, the CPU 301 controls the entire computer system 300. The memory 302 includes, for example, a read only memory (ROM), a random access memory (RAM), a flash ROM, and the like. More specifically, for example, the flash ROM stores a program such as an OS or firmware, the ROM stores an application program, and the RAM is used as a work area of the CPU 301. The program stored in the memory 302 is loaded on the CPU 301 to cause the CPU 301 to perform a coded process.

The I/F 303 controls data input and output to and from the other devices. Specifically, for example, the I/F 303 is connected to a network such as a local area network (LAN), a wide area network (WAN), or the Internet through a communication line, and is connected to the other devices via the network. Further, the I/F 303 is the interface between the inside of the system and the network to control data input and output to and from the other devices.

Furthermore, the computer system 300 may include, for example, a magnetic disk drive, a magnetic disc, a display, a keyboard, a mouse, and an image sensor in addition to the above-described units. The accelerator 304 includes hardware which implements a part of the CPU moving image process.

(Edge Perpendicular Component of Block B)

Next, a specific example of the pixel component which is substantially perpendicular to the edge direction of the block B partitioned and divided from the frame F will be described. In the following description, there may be cases where the pixel component which is substantially perpendicular to the edge direction of the block B is referred to as an “edge perpendicular component”. The edge perpendicular component corresponds to the first pixel component described above.

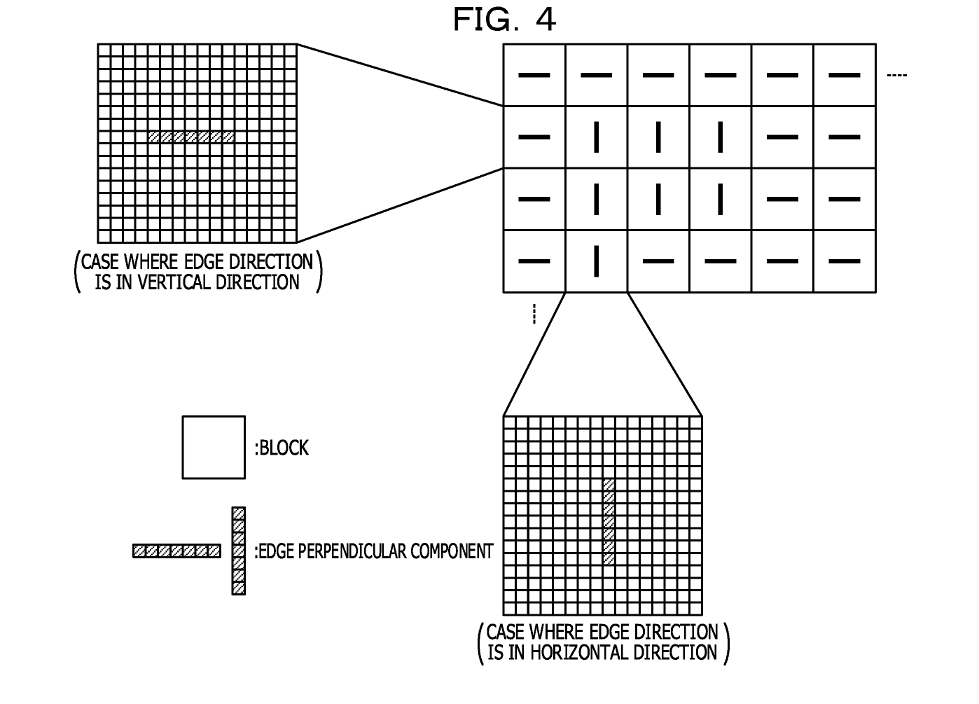

FIG. 4 is an explanatory view illustrating the specific example of the edge perpendicular component of the block B. In FIG. 4, for each of the blocks B partitioned and divided from the frame F, the edge perpendicular components which are substantially perpendicular to the edge directions of the blocks B are illustrated. The frame F is any frame among the series of frames as a moving image.

Here, the block B is a block of 16×16 pixels. In a case where the edge direction of the block B is the vertical direction, the edge perpendicular component of the block B is a horizontal (7×1 pixels) pixel row at the center potion of the block B. On the other hand, in a case where the edge direction of the block B is the horizontal direction, the edge perpendicular component of the block B is a vertical (1×7 pixels) pixel row at the center potion of the block B.

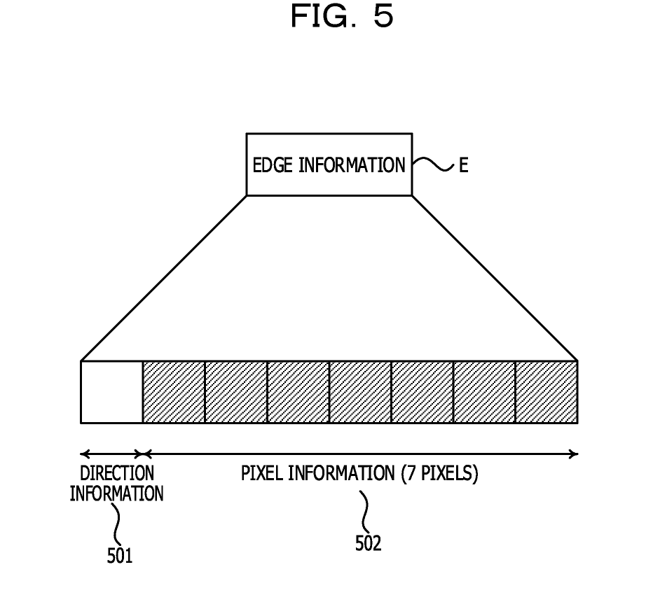

The image processing apparatus 100 generates edge information E indicating the edge perpendicular component of the block B. The data structure of the edge information E will be described later with reference to FIG. 5. Here, each of the blocks B divided from the frame F is a block of 16×16 pixels, but is not limited thereto. For example, each of the blocks B may be a block of 32×32 pixels or 64×64 pixels.

(Data Structure of Edge Information E)

Next, the data structure of the edge information E which is generated for each of the blocks B partitioned and divided from the frame F will be described.

FIG. 5 is an explanatory view illustrating an example of the data structure of the edge information E. In FIG. 5, the edge information E includes direction information 501 and pixel information 502. The direction information 501 is 1-byte information which indicates whether the direction of the edge perpendicular component of the block B is the vertical direction or the horizontal direction. The pixel information 502 is 7-byte information which indicates the information (1 byte) on each of the pixels of the vertical (1×7 pixels) or horizontal (7×1 pixels) edge perpendicular component.

(Stored Content of Edge Information Table 600)

Next, stored content of an edge information table 600 used in the image processing apparatus 100 will be described. The edge information table 600 is realized by, for example, the memory 302 illustrated in FIG. 3.

In the following description, a series of frames as a moving image is referred to as “frames F1 to Fn” (n is a natural number of 2 or greater), and an arbitrary frame among the frames F1 to Fn is referred to as a “frame Fi” (i=1, 2, . . . , n). In addition, a plurality of blocks partitioned and divided from the frame Fi are referred to as “blocks B1 to Bm” (m is a natural number of 2 or greater), and an arbitrary block among the blocks B1 to Bn is referred to as a “block Bj” (j=1, 2, . . . , m).

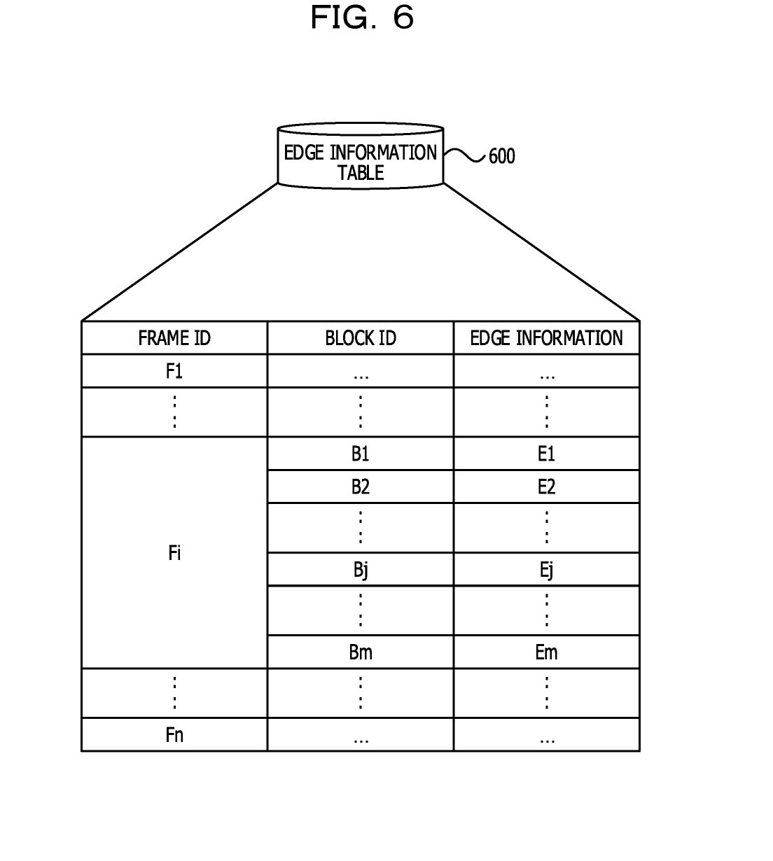

FIG. 6 is an explanatory view illustrating an example of the stored content of the edge information table 600. In FIG. 6, the edge information table 600 includes edge information E1 to Em of the blocks B1 to Bm partitioned and divided from the frame Fi for every frame Fi included in the frames F1 to Fn. A frame ID is an identifier which identifies the frame Fi. A block ID is an identifier which identifies the block Bj. The edge information is edge information Ej of the block Bj.

(Example of Functional Configuration of Image Processing Apparatus 100)

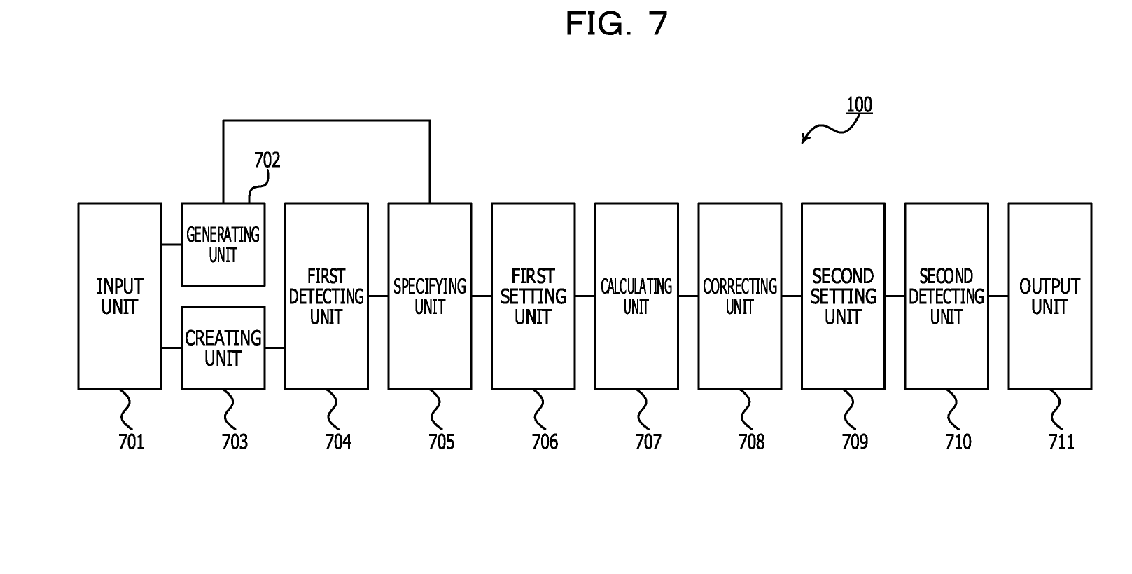

FIG. 7 is a block diagram illustrating an example of the functional configuration of the image processing apparatus 100. In FIG. 7, the image processing apparatus 100 has the configuration including an input unit 701, a generating unit 702, a creating unit 703, a first detecting unit 704, a specifying unit 705, a first setting unit 706, a calculating unit 707, a correcting unit 708, a second setting unit 709, a second detecting unit 710, and an output unit 711. Specifically, each of the function units may be formed by an element such as AND as an AND gate, INVERTER as a NOT gate, OR as an OR gate, NOR as a NOR gate, or flip-flop (FF) as a latch circuit. Further, each of the function units may be functionally defined by techniques such as the verilog-hardware description language (HDL), and may be realized by the field programmable gate array (FPGA) through logic synthesis of the techniques. In addition, the function of each of the function units may be implemented by causing the CPU 301 or the accelerator 304 to execute the program stored in the memory 302 illustrated in FIG. 3, or may be realized by causing the CPU 301 and the accelerator 304 to share the process. The processing result of each of the function units is, for example, stored in the memory 302.

The input unit 701 has a function of receiving inputs of the frames F1 to Fn. The frames F1 to Fn are, for example, moving images to be encoded. Specifically, for example, the input unit 701 receives the inputs of the frames F1 to Fn from the other devices via the I/F 303. The received frames F1 to Fn are stored in, for example, the memory 302 illustrated in FIG. 3.

The generating unit 702 has a function of generating the edge information Ej of the block Bj partitioned and divided from the frame Fi. Specifically, for example, first, the generating unit 702 detects the edge of the block Bj divided from the frame Fi using a Sobel filter. The Sobel filter is a filter which detects an outline by calculating a first spatial derivative.

The following expressions (4) and (5) represent the result of applying the Sobel filter to the block Bj in the vertical and horizontal directions. In addition, the following expression (6) represents an edge strength (gradient strength) of the block Bj. Px and Py are edge strengths in the x and y directions, respectively.

$$\begin{matrix}Lx = [ \begin{matrix}- 1 & 0 & + 1 \\ - 2 & 0 & + 2 \\ - 1 & 0 & + 1\end{matrix} ] \times {I}_{MB} & ( 4 ) \\ Ly = [ \begin{matrix}+ 1 & + 2 & + 1 \\ 0 & 0 & 0 \\ - 1 & - 2 & - 1\end{matrix} ] \times {I}_{MB} & ( 5 ) \\ P = \sqrt{{( Lx )}^{2} + {( Ly )}^{2}} \\ Px = \sqrt{{( Lx )}^{2}} , Py = \sqrt{{( Ly )}^{2}} & ( 6 )\end{matrix}$$

In a case where the edge strengths P in the x and y directions are greater than a threshold which is set in advance and the edge strength Px is greater than the edge strength Py, the generating unit 702 detects the edge of the block Bj in the vertical direction. The generating unit 702 extracts the pixel component which is substantially perpendicular to the edge direction (vertical direction) from the block Bj as the edge perpendicular component, and generates the edge information Ej of the block Bj.

In addition, in a case where the edge strengths Px and Py in the x and y directions are greater than the threshold and the edge strength Py is greater than the edge strength Px, the generating unit 702 detects the edge of the block Bj in the horizontal direction. The generating unit 702 extracts the pixel component which is substantially perpendicular to the edge direction (horizontal direction) from the block Bj as the edge perpendicular component, and generates the edge information Ej of the block Bj.

In addition, in a case where the edge strengths Px and Py in the x and y directions are smaller than the threshold, the generating unit 702 generates edge information Ej indicating that there is no edge in the block Bj. The generated edge information Ej of the block Bj is stored in, for example, the edge information table 600 illustrated in FIG. 6.

Furthermore, the generating unit 702 may generate the edge information Ej on a direction (angle θ) other than the vertical and horizontal directions by calculating an angle θ of the edge of the block Bj. In this case, the information indicating the direction of the edge perpendicular component is stored in, for example, the direction information 501 of the edge information Ej. The angle θ may be obtained, for example, using the following expression (7).

θ=tan⁻¹(Py/Px) (7)

The creating unit 703 has a function of creating a reduced image reduced from the frame Fi at a predetermined reduction ratio r. Specifically, for example, in a case where the reduction ratio r is “r=0.25”, the creating unit 703 creates the reduced image of the frame Fi by subsampling the frame Fi in both the horizontal and vertical directions by ¼. The created reduced image of the frame Fi is stored in, for example, the memory 302.

The first detecting unit 704 has a function of detecting the first motion vector V1 of the target block TB partitioned and divided from the target frame TF based on the reduced image of the target frame TF and the reduced image of the reference frame RF. Here, the first motion vector V1 is a vector which indicates the difference in the spatial position between the block divided from the reduced image of the target image OP and the reference block in the search range in the reduced image of the reference image RP.

In the following description, there may be cases where a block corresponding to the target block TB among the blocks divided from the reduced image of the target frame TF is referred to as a “target block tb”. In addition, there may be cases where a block in the search range in the reduced image of the reference frame RF is referred to as a “reference block rb”.

Specifically, for example, the first detecting unit 704 sequentially selects the reference blocks rb in the search range in the reduced image of the reference frame RF at a 1-pixel accuracy (or ½-pixel accuracy, ¼-pixel accuracy, or the like). In addition, the search range in the reduced image of the reference frame RF is designated in advance. The search range is, for example, a range of ±15 pixels from the position of the target block tb in the reduced image of the reference frame RF as the center.

Subsequently, the first detecting unit 704 calculates the evaluation value of each of the reference blocks rb by cumulatively adding the values which represent the differences between the pixels corresponding to the target block tb and the reference block rb. The first detecting unit 704 detects the first motion vector V1 of the target block TB based on the calculated evaluation value of each of the reference block rb. Here, the evaluation value of the reference block rb is, for example, SAD, SATD, or SSD.

Specifically, for example, the first detecting unit 704 detects a vector V (X, Y) corresponding to the reference block rb having the minimum evaluation value among the reference blocks rb in the search range in the reduced image of the reference frame RF. The first detecting unit 704 detects a vector obtained by enlarging the detected vector V (X, Y) by the reciprocal of the reduction ratio r as the first motion vector V1 (X/r, Y/r).

The specifying unit 705 has a function of specifying the edge perpendicular component of the block Bj in the reference frame RF based on the first motion vector V1 detected by the first detecting unit 704. Specifically, for example, first, in a case where the target block TB is disposed at a position in the reference frame RF indicated by the first motion vector V1, the specifying unit 705 specifies the block Bj in the reference frame RF that overlaps the target block TB.

Next, the specifying unit 705 determines a degree of overlap between the edge perpendicular components of the block Bj in the specified reference frame RF and the target block TB with reference to the edge information table 600 illustrated in FIG. 6. At this time, the direction of the edge perpendicular component may be specified from the direction information 501 of the edge information Ej. In addition, the position of the edge perpendicular component is, for example, at the center portion of the block Bj which is set in advance. The specifying unit 705 specifies the edge information Ej indicating the edge perpendicular component of the block Bj in the reference frame RF having the maximum degree of overlap with the target block TB with reference to the edge information table 600. Accordingly, among the edge perpendicular components in the vicinity of the point in the reference frame RF indicated by the first motion vector V1, an appropriate edge perpendicular component EC for performing block matching with the target block TB can be specified.

Furthermore, there is a high possibility that as the degree of overlap of the block Bj with the target block TB is increased, the degree of overlap between the edge perpendicular component of the block Bj and the target block TB may be increased. Therefore, for example, the specifying unit 705 may specify the block Bj having the maximum degree of overlap with the target block TB, which is disposed at the position in the reference frame RF indicated by the first motion vector V1, to specify the edge information Ej indicating the edge perpendicular component of the block Bj.

In the following description, there may be cases where the edge perpendicular component of the block Bj in the reference frame RF specified by the specifying unit 705 is referred to as the “edge perpendicular component EC”.

The first setting unit 706 has a function of setting the search range which includes the pixel row in the target block TB corresponding to the edge perpendicular component EC specified by the specifying unit 705 and is parallel to the pixel row. Specifically, for example, the first setting unit 706 sets the search range to a range which includes the pixel row in the target block TB corresponding to the edge perpendicular component EC and in which the pixel row is shifted in parallel by ±k pixels. In addition, the value of k may be arbitrarily set, and is set by considering, for example, the amount of operation for block matching between the edge perpendicular component and the target block TB. Specifically, for example, k is a value of about ½ to ⅓ of the reciprocal of the reduction ratio r.

In the following description, there may be cases where the search range in the target frame TF set by the first setting unit 706 is referred to as a “search range SR1”.

For the search range SR1 set by the first setting unit 706, the calculating unit 707 has a function of calculating the evaluation value v which represents the difference between the pixel value of the edge perpendicular component and the pixel value of the pixel component for each of the pixel components in the search range SR1 corresponding to the edge perpendicular component EC. That is, the calculating unit 707 performs block matching between the edge perpendicular component and the target block TB. Here, the pixel component in the search range SR1 corresponding to the edge perpendicular component EC is a pixel row in the search range SR1 having the same form as that of the edge perpendicular component EC.

In the following description, there may be cases where the pixel component in the search range SR1 corresponding to the edge perpendicular component EC is referred to as a “target pixel component TC”. When the edge perpendicular component EC is assumed to be a pixel component having 1 row, there are (2k+1) target pixel components TC in the search range SR1. The evaluation value v of the target pixel component TC is, for example, SAD, SATD, or SSD.

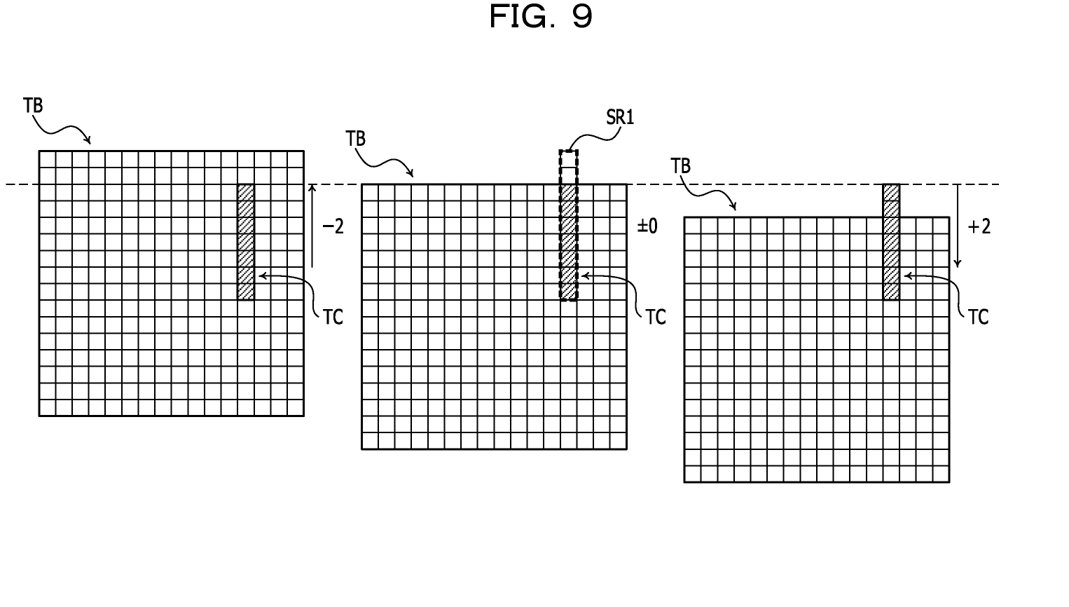

Specifically, for example, the calculating unit 707 calculates the evaluation value v of each of the target pixel components TC by cumulatively adding values which represent the differences between the pixels corresponding to the edge perpendicular component EC and the target pixel component TC. Further, there may be cases where the pixel component in the search range SR1 corresponding to the edge perpendicular component EC deviates from the target block TB. Examples of countermeasure against this case will be described later with reference to FIGS. 9 to 12.

The correcting unit 708 has a function of correcting the first motion vector V1 based on the evaluation value v of each of the target pixel components TC calculated by the calculating unit 707. Specifically, for example, first, the correcting unit 708 specifies k corresponding to the minimum evaluation value v_min among the evaluation values v of the target pixel components TC. The correcting unit 708 corrects the first motion vector V1 by, for example, substituting the specified k by the correction amount k into the above expression (1) or (2).

More specifically, for example, in a case where the target pixel component TC is parallel to the x-axis, the correcting unit 708 corrects the first motion vector V1 by substituting the correction amount k into the above expression (1). In addition, in a case where the target pixel component TC is parallel to the y-axis, the correcting unit 708 corrects the first motion vector V1 by substituting the correction amount k into the above expression (2).

The second setting unit 709 has a function of setting the search range SR2 in the reference frame RF based on the first motion vector V1 after being corrected by the correcting unit 708 and the direction of the target pixel component TC. Here, the direction of the target pixel component TC is a direction substantially perpendicular to the edge direction of the block Bj. In addition, the search range SR2 is a search range in the motion estimation of the detailed ME.

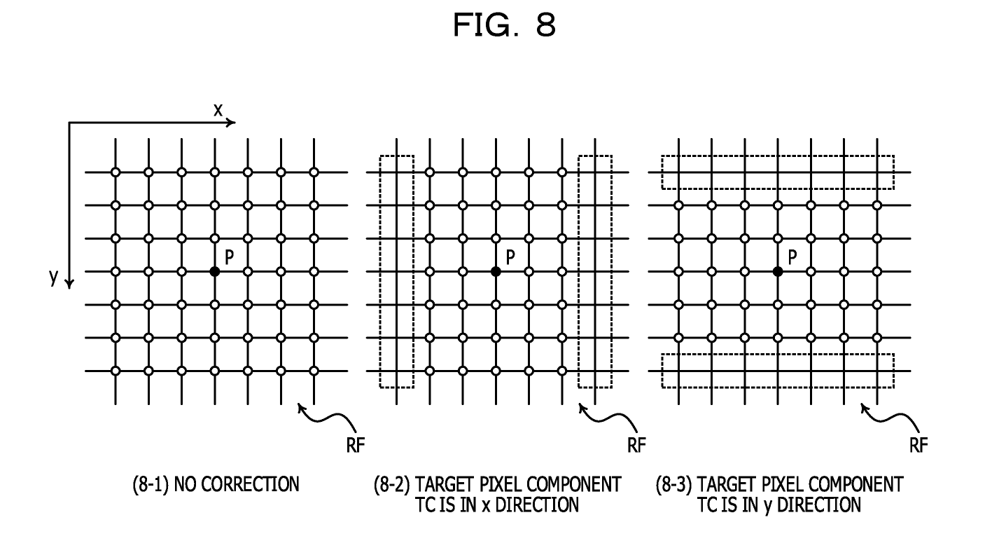

Specifically, for example, the second setting unit 709 sets the search range SR2 to a rectangular area in which the width in the direction parallel to the target pixel component TC is smaller than the width in the direction perpendicular to the target pixel component TC (edge perpendicular component EC) with respect to a point as the center in the reference frame RF indicated by the motion vector V1 after being corrected. Examples of setting the search range SR2 will be described later with reference to FIG. 8.

The second detecting unit 710 has a function of detecting a second motion vector V2 of the target block TB partitioned and divided from the target frame TF, based on the target frame TF and the reference frame RF. Here, the second motion vector V2 is a motion vector detected in the motion estimation of the detailed ME.

Specifically, for example, first, for the search range SR2 in the reference frame RF set by the second setting unit 709, the second detecting unit 710 calculates an evaluation value V which represents the difference between the pixel value of the target block TB and the pixel value of the reference block RB for each of the reference blocks RB in the search range SR2 corresponding to the target block TB. The evaluation value V of the reference block RB is, for example, SAD, SATD, or SSD.

Then, the second detecting unit 710 detects the second motion vector V2 of the target block TB based on the calculated evaluation value V of each of the reference blocks RB. More specifically, for example, the second detecting unit 710 detects a vector corresponding to the reference block RB having the minimum evaluation value among the reference blocks RB in the search range SR2 of the reference frame RF as the second motion vector V2.

Furthermore, when the evaluation value V of the reference block RB is calculated, during a process of cumulatively adding the values which represent the differences between the pixels, in a case where the value as the cumulative sum becomes greater than the calculated evaluation value of another reference block RB, the second detecting unit 710 may stop the cumulative addition. That is, even when the cumulative addition is continuously performed thereafter, the evaluation value does not represent the optimum value. Therefore, the second detecting unit 710 may stop the process of calculating the evaluation value V of the reference block RB.

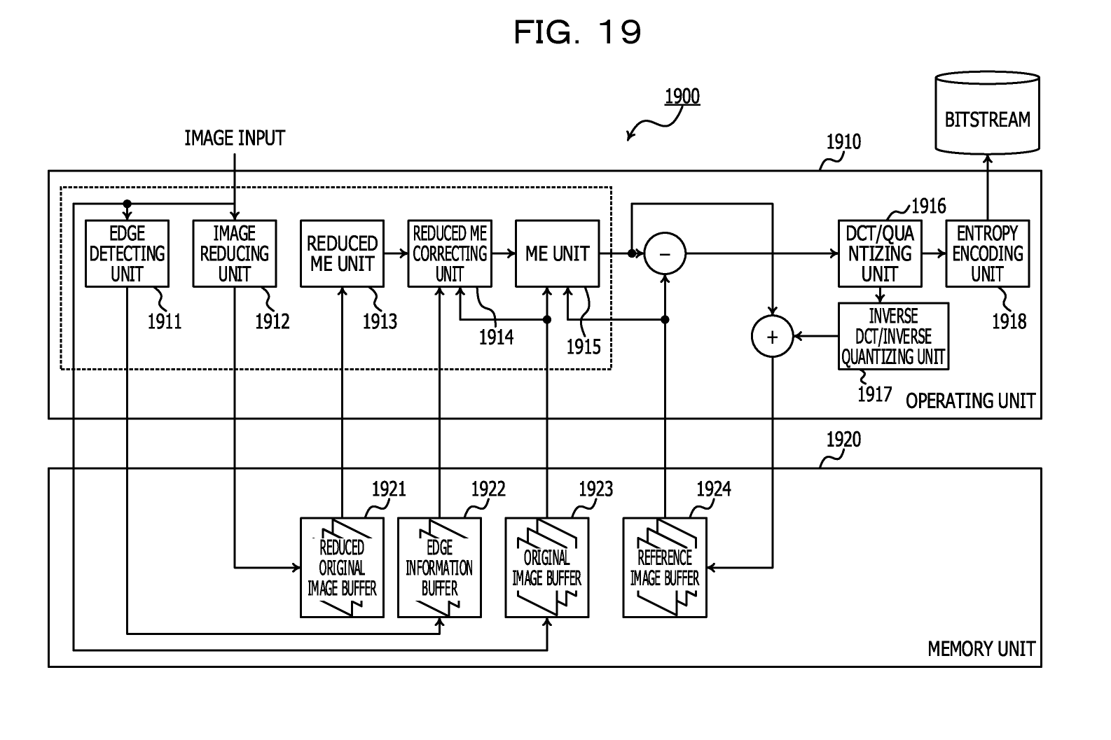

The output unit 711 has a function of outputting the second motion vector V2 of the target block TB detected by the second detecting unit 710. Specifically, for example, the output unit 711 outputs the second motion vector V2 of the target block TB to a function unit (for example, a DCT/quantizing unit 1916 illustrated in FIG. 19, which will be described later) which transforms a difference image into a frequency component and quantizes the resultant component.

(Examples of Setting Search Range SR2)

Next, examples of setting the search range SR2 in the motion estimation of the detailed ME will be described.

FIG. 8 is an explanatory view illustrating the examples of setting the search range SR2. In FIG. 8, (8-1) is an example of setting the search range SR2 in a case where the first motion vector V1 is not corrected by the correcting unit 708. Here, the search range SR2 having ±3 pixels in the x direction and ±3 pixels in the y direction from the point P as the center in the reference frame RF indicated by the first motion vector V1 is set as an initial range.

(8-2) is an example of setting the search range SR2 in a case where the first motion vector V1 is corrected by the correcting unit 708 and the target pixel component TC is in the x direction. Here, the position accuracy in the x direction is higher than that in the y direction because correction is performed using the target pixel component TC, and thus the search range SR2 is set by removing one vertical row (in FIG. 8, dotted-line frame) in each of the right and left rows from the initial setting. Accordingly, the search range in the detailed ME may be limited compared to the initial range.

(8-3) is an example of setting the search range SR2 in a case where the first motion vector V1 is corrected by the correcting unit 708 and the target pixel component TC is in the y direction. Here, the position accuracy in the y direction is higher than that in the x direction because correction is performed using the target pixel component TC, and thus the search range SR2 is set by removing one horizontal row (in FIG. 8, dotted-line frame) in each of the top and bottom rows from the initial setting. Accordingly, the search range in the detailed ME may be limited compared to the initial range.

Here, the case of reducing the initial setting by one row in a fixed manner depending on the direction (the x direction or the y direction) of the target pixel component TC is described, but this embodiment is not limited thereto. Specifically, for example, the second setting unit 709 may determine the number of rows to be reduced, based on the edge strength P at the time of detecting the edge of the block Bj in the reference frame RF corresponding to the edge perpendicular component EC, and the evaluation value v_min of the target pixel component TC.

More specifically, for example, the second setting unit 709 may determine the number of rows to be reduced as “2”, that is, determine the number of rows to be removed from the initial setting of the search range SR2 as “2” in a case where the conditions of “P>threshold α, and S>threshold β” are satisfied. In addition, in a case where the conditions are not satisfied, the second setting unit 709 may determine the number of rows to be reduced as “1”, that is, determine the number of rows to be removed from the initial setting of the search range SR2 as “1”.

For example, the edge strength P of the block Bj may be included in the edge information Ej of the block Bj. In addition, for example, the thresholds α and β are set in advance and stored in the memory 302.

(Examples of Countermeasure when Block Matching of Edge Perpendicular Component EC is Performed)

Next, the examples of countermeasure against the case where the pixel component in the search range SR1 corresponding to the edge perpendicular component EC deviates from the target block TB when block matching between the edge perpendicular component EC and the target block TB is performed will be described. Here, there are cases where the pixel component in the search range SR1 corresponding to the edge perpendicular component EC deviates from the target block TB, the cases including the following (i) and (ii):

(i) The case where a part or the entirety of the edge perpendicular component EC deviates from the target block TB.

(ii) The case where the pixel component corresponding to the edge perpendicular component EC in the search range SR1 in the target frame TF is changed and deviates from the target block TB.

FIG. 9 is an explanatory view illustrating an example of the case where the pixel component corresponding to the edge perpendicular component EC deviates from the target block TB. In FIG. 9, the positional relationship between the target block TB and the search range SR1 in the target frame TF is illustrated. Here, in a case of “k=±0”, the entirety of the target pixel component TC corresponding to the edge perpendicular component EC is included in the target block TB.

Similarly, in a case of “k=+2”, the entirety of the target pixel component TC corresponding to the edge perpendicular component EC is included in the target block TB. In addition, in a case of “k=−2”, the entirety of the target pixel component TC corresponding to the edge perpendicular component EC deviates from the target block TB. In the above cases, the evaluation value v of the target pixel component TC may not be calculated even when block matching between the edge perpendicular component EC and the target block TB is performed. Hereinafter, the examples of countermeasure against these cases will be described.

<First Example of Countermeasure>

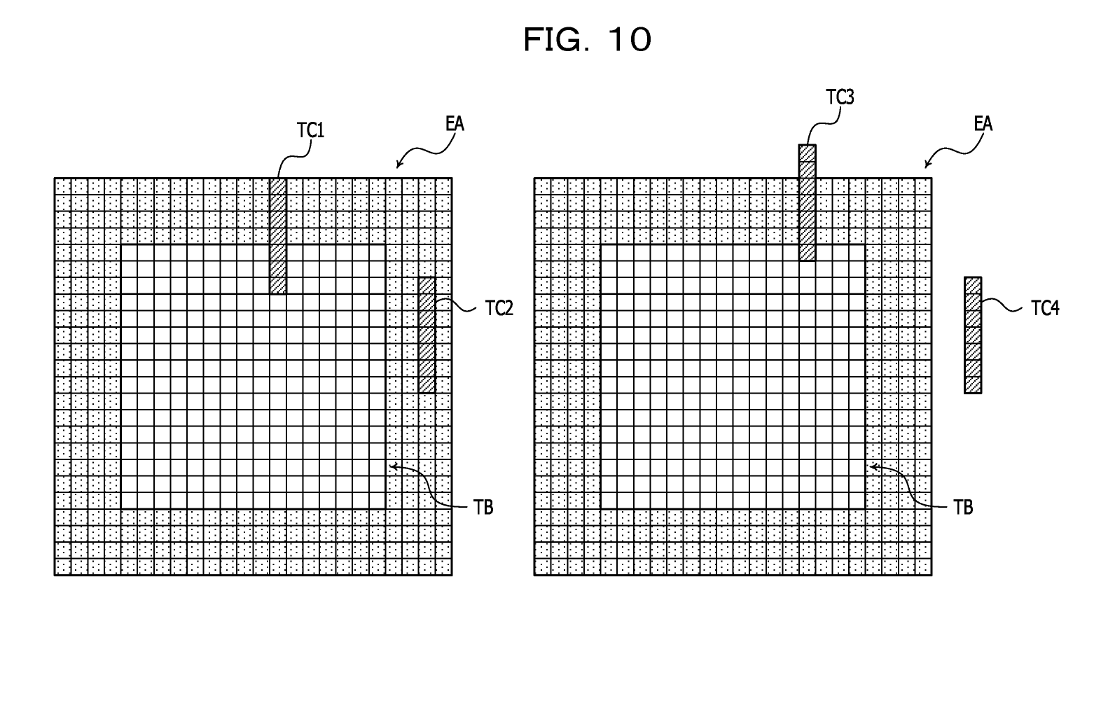

FIG. 10 is an explanatory view illustrating a first example of countermeasure against the case where the pixel component corresponding to the edge perpendicular component EC deviates from the target block TB. In FIG. 10, the positional relationship between the target block TB and the target pixel components TC1 to TC4 corresponding to the edge perpendicular component EC is illustrated.

In a case where the target pixel component TC deviates from the target block TB, the evaluation value v of the target pixel component TC may be calculated by using pixels in the vicinity of the target block TB, that is, by reading the pixels in the vicinity of the target block TB from the memory 302. In addition, for example, a degree of extension of the pixels in the vicinity of the target block TB to be read may be specified from, for example, the first motion vector V1, the edge information E, and the search range SR1 in the target frame TF.

However, when the motion search is performed by reading pixels which are far from the target block TB, an appropriate result may not be obtained. Therefore, there is provided a limitation to the surrounding pixels which can be read through the extension. For example, the surrounding pixels which can be read through the extension are N pixels (for example, N=4 pixels) in the vicinity of the target block TB.

In a case where the target pixel component TC is included in a rectangular area EA which is enlarged to have N pixels in the vicinity of the target block TB, the calculating unit 707 calculates the evaluation value v of the target pixel component TC. On the other hand, in a case where the target pixel component TC deviates from the rectangular area EA, the calculating unit 707 does not calculate the evaluation value v of the target pixel component TC. That is, in the case where the target pixel component TC deviates from the rectangular area EA, correction of the first motion vector V1 is not performed.

In the example of FIG. 10, the target pixel components TC1 and TC2 are included in the rectangular area EA. Therefore, by cumulatively adding values which represent the differences between the pixels corresponding to the edge perpendicular component EC and the target pixel components TC1 and TC2, the calculating unit 707 calculates the evaluation value v for each of the target pixel components TC1 and TC2. In contrast, the target pixel components TC3 and TC4 deviate from the rectangular area EA. Therefore, the calculating unit 707 does not calculate the evaluation values v of the target pixel components TC3 and TC4.

As described above, even in the case where the target pixel component TC deviates from the target block TB, the evaluation value v of the target pixel component TC may be calculated by reading the pixels in the vicinity of the target block TB through the extension. In addition, since the limitation to the surrounding pixels which can be read through the extension is provided, the accuracy of the motion search may not be reduced.

<Second Example of Countermeasure>

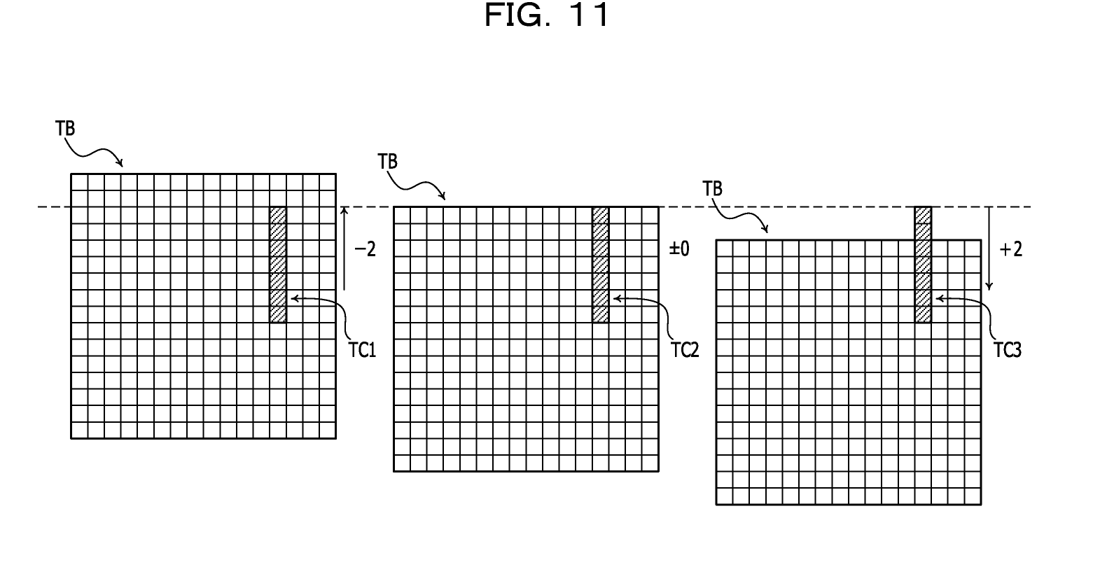

FIG. 11 is an explanatory view illustrating a second example of the countermeasure against the case where the pixel component corresponding to the edge perpendicular component EC deviates from the target block TB. In FIG. 11, the positional relationship between the target block TB and the target pixel components TC1 to TC3 corresponding to the edge perpendicular component EC is illustrated.

In a case where a part of the target pixel component TC deviates from the target block TB, the calculating unit 707 calculates the evaluation value of an overlapping part of the target pixel component TC which overlaps the target block TB. Subsequently, the calculating unit 707 calculates the evaluation value of the part of the target pixel component TC which deviates from the target block TB based on the average value of the calculated evaluation value of the overlapping part in units of pixels.

In the example of FIG. 11, the target pixel components TC1 and TC2 are included in the target block TB. Therefore, by cumulatively adding values which represent the differences between the pixels corresponding to the edge perpendicular component EC and the target pixel components TC1 and TC2, the calculating unit 707 calculates the evaluation value v for each of the target pixel components TC1 and TC2.

On the other hand, the target pixel component TC3 deviates from the target block TB. In this case, first, the calculating unit 707 calculates an evaluation value v[1] of the overlapping part of the target pixel component TC3 which overlaps the target block TB, that is, the five pixels. The calculating unit 707 calculates the average value “v[1]/5” in units of pixels of the evaluation value v[1] for the five pixels.

Subsequently, the calculating unit 707 calculates an evaluation value v[2] of the part of the target pixel component TC3 which deviates from the target block TB, that is, the two pixels, based on the average value “v[1]/5” in units of pixels. Here, the evaluation value v[2] becomes “v[2]=2×v[1]/5”. The calculating unit 707 calculates the evaluation value v of the target pixel component TC3 by adding the evaluation value v[1] of the five pixels and the evaluation value v[2] of the two pixels.

As described above, the evaluation value v[2] of the part of the target pixel component TC which deviates from the target block TB may be calculated based on the average value of the evaluation value v[1] of the overlapping part of the target pixel component TC which overlaps the target block TB. Accordingly, even in the case where the target pixel component TC deviates from the target block TB, the evaluation value v of the target pixel component TC may be calculated.

Here, in a case where there is no overlapping part between the target pixel component TC and the target block TB, the calculating unit 707 does not calculate the evaluation value v of the target pixel component TC. In addition, in a case where the part of the target pixel component TC which overlaps the target block TB is approximately ten percent of the entire target pixel component TC, the calculating unit 707 may not calculate the evaluation value v of the target pixel component TC. Accordingly, the accuracy of the motion search may not be reduced.

<Third Example of Countermeasure>

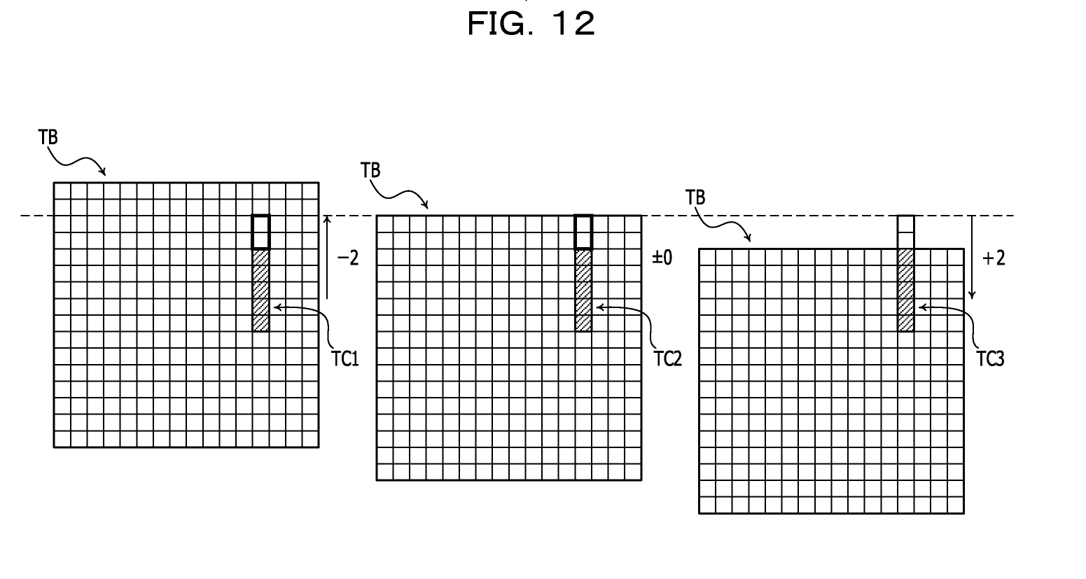

FIG. 12 is an explanatory view illustrating a third example of the countermeasure against the case where the pixel component corresponding to the edge perpendicular component EC deviates from the target block TB. In FIG. 12, the positional relationship between the target block TB and the target pixel components TC1 to TC3 corresponding to the edge perpendicular component EC is illustrated.

In a case where there is a target pixel component TC which deviates from the target block TB, the calculating unit 707 limits the pixels of the edge perpendicular component EC according to the target pixel component TC which least overlaps the target block TB. That is, the calculating unit 707 takes AND of the edge perpendicular component EC of which the evaluation value can be calculated.

In the example of FIG. 12, a part of the target pixel component TC3 deviates from the target block TB, and the overlapping part of the target pixel component TC3 which overlaps the target block TB is five pixels. In this case, the calculating unit 707 limits the edge perpendicular component EC of 7 pixels to 5 pixels. Specifically, the calculating unit 707 removes 2 pixels in the upper part, which is the part of the edge perpendicular component EC of 7 pixels that deviates from the target block TB.

Accordingly, the pixel component corresponding to the edge perpendicular component EC may not deviate from the target block TB. Here, in a case where there is no overlapping part between the target pixel component TC and the target block TB, the calculating unit 707 does not calculate the evaluation value v of the target pixel component TC. In addition, in a case where the part of the target pixel component TC which overlaps the target block TB is approximately ten percent of the entire target pixel component TC, the calculating unit 707 may not calculate the evaluation value v of the target pixel component TC.

<Fourth Example of Countermeasure>

As a fourth example of the countermeasure, in a case where a part or the entirety of the target pixel component TC deviates from the target block TB, the calculating unit 707 may not calculate the evaluation value v of the target pixel component TC.

Which countermeasure method is to be selected as the countermeasure method for (i) and (ii) described above from the first to fourth examples of the countermeasure described above may be determined according to, for example, the initial settings. Specifically, as the countermeasure method for (i), for example, any countermeasure method of the first example of the countermeasure and the fourth example of the countermeasure is selected. In addition, as the countermeasure method for (ii), for example, any countermeasure method of the first example of the countermeasure, the second example of the countermeasure, the third example of the countermeasure, and the fourth example of countermeasure is selected.

(Variations on Edge Perpendicular Component)

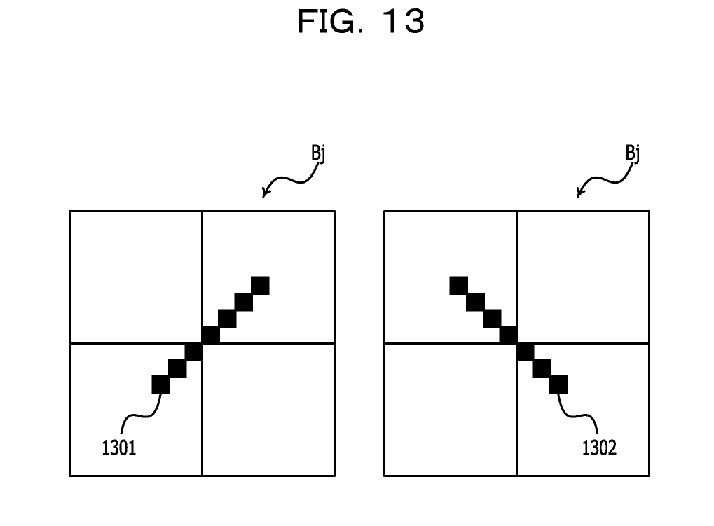

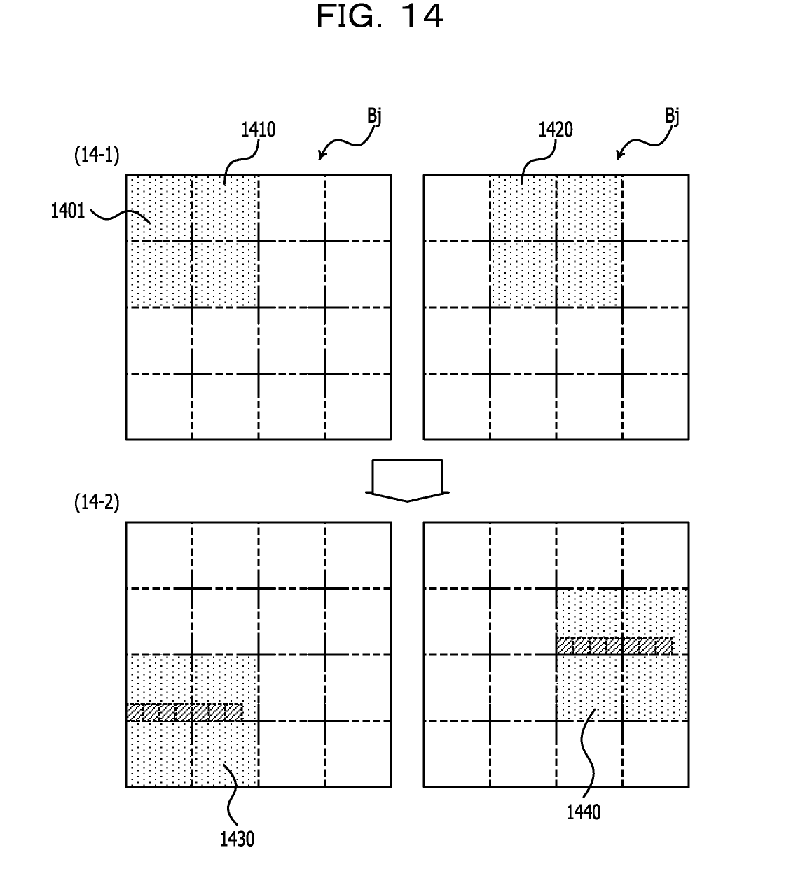

Next, with reference to FIGS. 13 and 14, variations on the edge perpendicular component of the block Bj partitioned and divided from the frame Fi will be described.

FIG. 13 is an explanatory view illustrating a variation on the edge perpendicular component (1 thereof). In FIG. 13, as the edge perpendicular component of the block Bj, inclined edge perpendicular components 1301 and 1302 are illustrated. In this case, 1-byte information which indicates, for example, whether the edge perpendicular component of the block Bj is in an upper right or a lower right direction is stored in the direction information 501 of the edge information E.

FIG. 14 is an explanatory view illustrating a variation on the edge perpendicular component (2 thereof). The generating unit 702 may divide the block Bj into a plurality of areas, and extract the edge perpendicular component at a position having the strongest edge (for example, the largest value after filtration by the Sobel Filter or the like) from among the plurality of areas.

In the example of FIG. 14, the block Bj of 16×16 pixels is divided into 16 blocks (for example, block 1401) of 4×4 pixels. In this case, the generating unit 702 determines whether or not the edge of each of 9 points (for example, areas 1410, 1420, 1430, and 1440) in units of 4 blocks is present in the block Bj (8×8 pixels) ((14-1) in FIG. 14).

The generating unit 702 generates the edge information on the point (for example, the areas 1430 and 1440) having the largest filtration result as the edge information E of the block Bj ((14-2) in FIG. 14). In this case, since the position where the edge perpendicular component is extracted varies with the block Bj, the generating unit 702 adds the position information (for example, 0 to 8) indicating the position in the block Bj where the edge perpendicular component is extracted to the edge information E. In addition, the specifying unit 705 specifies and determines the block Bj in the reference frame RF which overlaps the target block TB, with reference to the position information (0 to 8) included in the edge information E.

(Image Processing Procedure of Image Processing Apparatus 100)

Next, an image processing procedure of the image processing apparatus 100 will be described. Here, as an example of the image processing performed by the image processing apparatus 100, a process of detecting the motion vector of the target block TB divided from the target frame TF will be described.

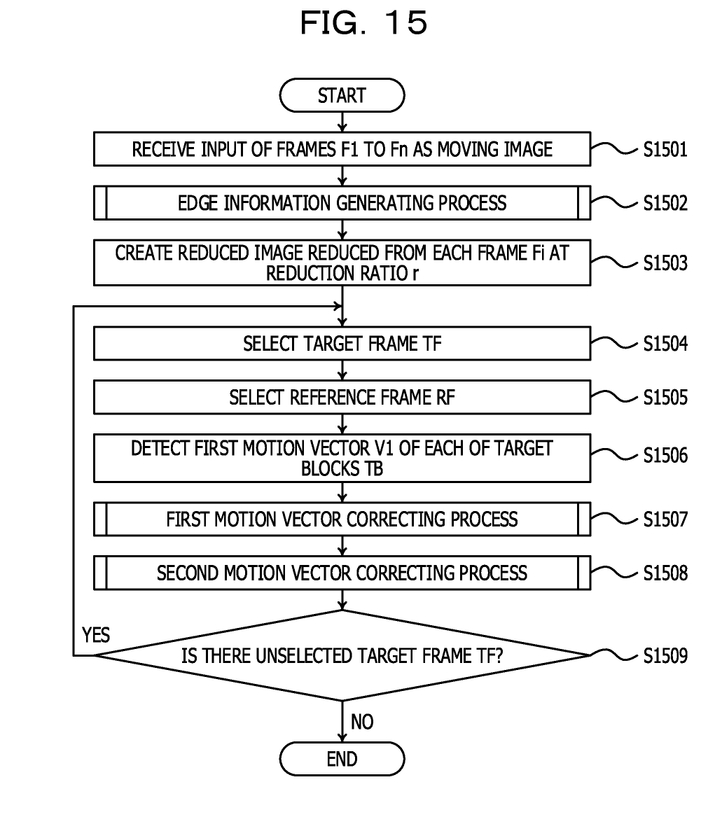

FIG. 15 is a flowchart illustrating an example of the image processing procedure of the image processing apparatus 100. In the flowchart of FIG. 15, first, the image processing apparatus 100 receives the input of the frames F1 to Fn as a moving image (Step S1501).

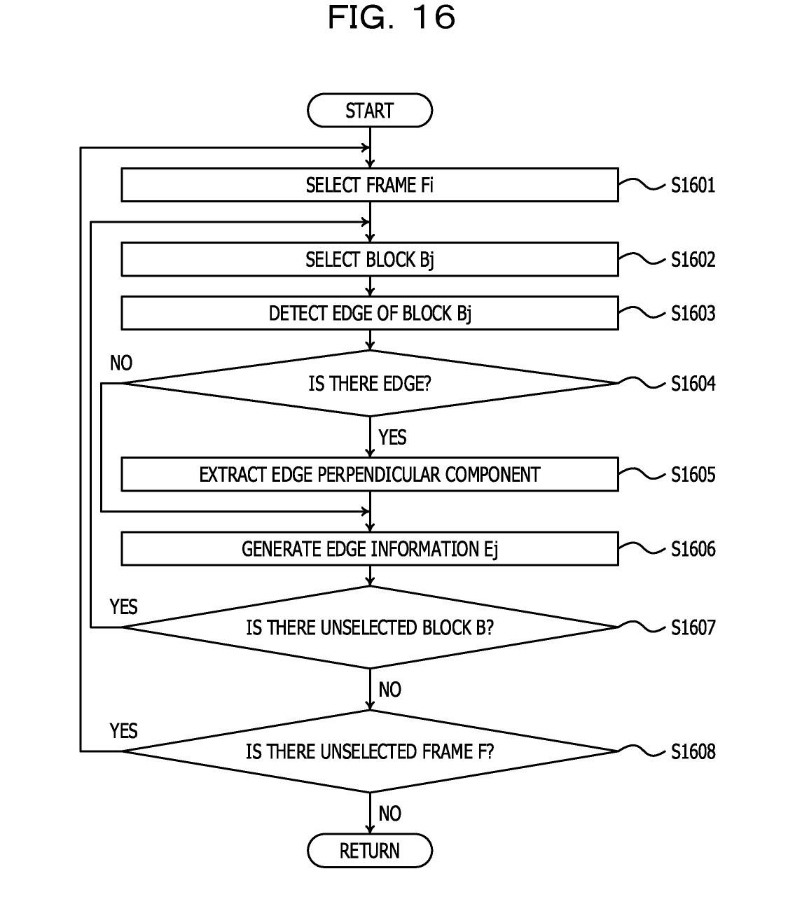

Subsequently, the image processing apparatus 100 performs an edge information generating process of generating the edge information Ej of the block Bj partitioned and divided from the frame Fi (Step S1502). In addition, a specific processing procedure of the edge information generating process will be described later with reference to FIG. 16.

The image processing apparatus 100 creates a reduced image reduced from the frame Fi included in the frames F1 to Fn at the reduction ratio r (Step S1503). Subsequently, the image processing apparatus 100 selects a target frame TF which is the processing target from the frames F1 to Fn (Step S1504), and selects a reference frame RF which is the reference destination of the target frame TF (Step S1505).

The image processing apparatus 100 detects the first motion vector V1 of each of the target blocks TB partitioned and divided from the target frame TF based on the reduced image of the target frame TF and the reduced image of the reference frame RF (Step S1506).

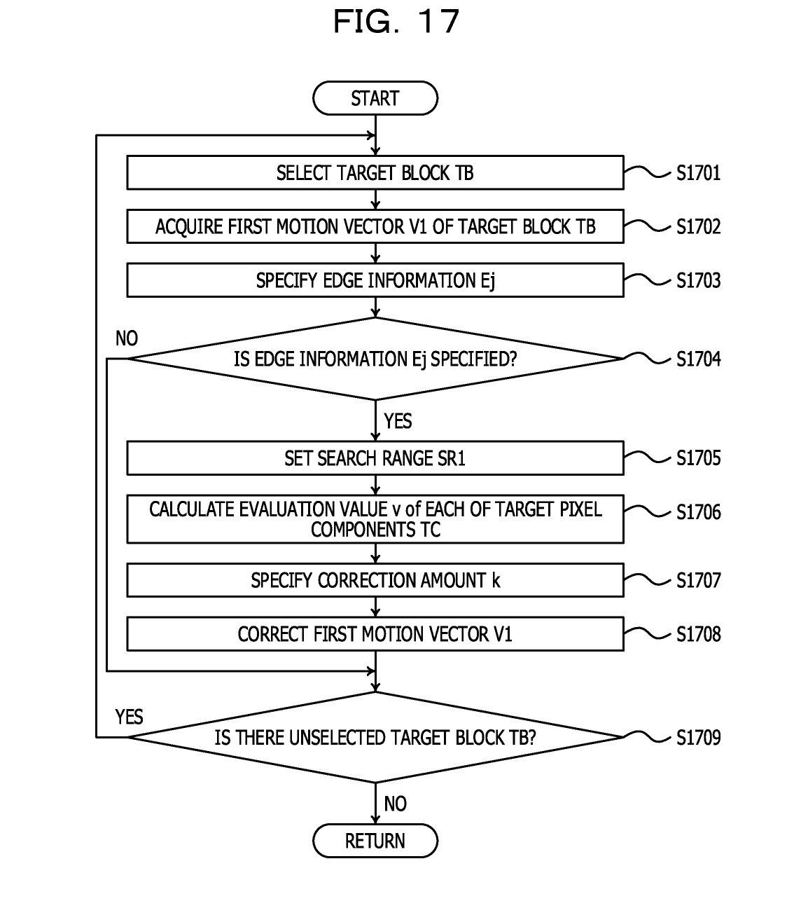

Subsequently, the image processing apparatus 100 performs a first motion vector correcting process of correcting the first motion vector V1 of each of the target blocks TB (Step S1507). In addition, a specific processing procedure of the first motion vector correcting process will be described later with reference to FIG. 17.

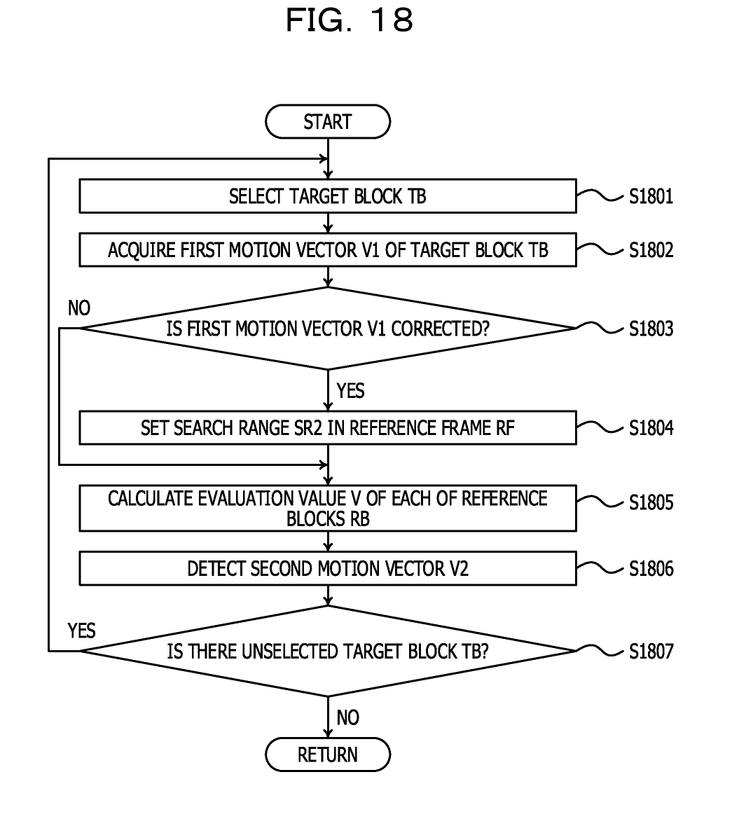

The image processing apparatus 100 performs a second motion vector detecting process of detecting the second motion vector V2 of each of the target blocks TB (Step S1508). In addition, a specific processing procedure of the second motion vector detecting process will be described later with reference to FIG. 18.

Subsequently, the image processing apparatus 100 determines whether or not there is an unselected target frame TF which is not selected from the frames F1 to Fn (Step S1509). Here, in a case where there is an unselected target frame TF (Yes in Step S1509), the image processing apparatus 100 returns to Step S1504 to select the unselected target frame TF from the frames F1 to Fn.

In contrast, in a case where there is no unselected target frame TF (No in Step S1509), the image processing apparatus 100 ends a series of processes according to the flowchart. Accordingly, the second motion vector V2 for each of the target blocks TB partitioned and divided from the target frame TF included in the frames F1 to Fn as the moving image can be detected.

<Specific Processing Procedure of Edge Information Generating Process>

Next, the specific processing procedure of the edge information generating process of Step 1502 illustrated in FIG. 15 will be described.

FIG. 16 is a flowchart illustrating an example of the specific processing procedure of the edge information generating process. In the flowchart of FIG. 16, first, the image processing apparatus 100 selects the frame Fi from the frames F1 to Fn (Step S1601). Subsequently, the image processing apparatus 100 selects the block Bj partitioned and divided from the selected frame Fi (Step S1602).

The image processing apparatus 100 detects the edge of the selected block Bj (Step S1603). Subsequently, the image processing apparatus 100 determines whether or not there is an edge in the block Bj based on the detection result (Step S1604). Here, in a case where there is no edge (No in Step S1604), the image processing apparatus 100 proceeds to Step 1606.

In contrast, in a case where there is an edge (Yes in Step S1604), the image processing apparatus 100 extracts the pixel component which is substantially perpendicular to the edge direction from the block Bj as the edge perpendicular component (Step S1605). The image processing apparatus 100 generates the edge information Ej of the block Bj (Step S1606). In addition, in the case where there is no edge in the block Bj, the edge information Ej indicating that there is no edge in the block Bj is generated.

Subsequently, the image processing apparatus 100 determines whether or not there is an unselected block B which is not selected from the frame Fi (Step S1607). Here, in a case where there is an unselected block B (Yes in Step S1607), the image processing apparatus 100 returns to Step S1602 to select the unselected block Bj which is not selected from the frame Fi.

In contrast, in a case where there is no unselected block B (No in Step S1607), the image processing apparatus 100 determines whether or not there is an unselected frame F which is not selected from the frames F1 to Fn (Step S1608). Here, in a case where there is an unselected frame F (Yes in Step S1608), the image processing apparatus 100 returns to Step S1601 to select the unselected frame Fi which is not selected from the frames F1 to Fn.

In contrast, in a case where there is no unselected frame F (No in Step S1608), the image processing apparatus 100 ends a series of processes according to the flowchart, and returns to the step which calls the edge information generating process. Accordingly, the edge information E of each of the blocks B partitioned and divided from the frame F included in the frames F1 to Fn as the moving image can be generated.

<Specific Processing Procedure of First Motion Vector Correcting Process>

Next, the specific processing procedure of the first motion vector correcting process of Step S1507 illustrated in FIG. 15 will be described.

FIG. 17 is a flowchart illustrating an example of the specific processing procedure of the first motion vector correcting process. In the flowchart of FIG. 17, first, the image processing apparatus 100 selects the target block TB from the target frame TF (Step S1701), and acquires the first motion vector V1 of the target block TB (Step S1702).

Subsequently, the image processing apparatus 100 specifies the edge information Ej indicating the edge perpendicular component EC of the block Bj in the reference frame RF having the maximum degree of overlap with the target block TB, based on the first motion vector V1 (Step S1703). The image processing apparatus 100 determines whether or not the edge information Ej is specified (Step S1704).

In a case where the edge information Ej is not specified (No in Step S1704), the image processing apparatus 100 proceeds to Step S1709. In contrast, in a case where the edge information Ej is specified (Yes in Step S1704), the image processing apparatus 100 sets the search range SR1 which includes the pixel row in the target frame TF corresponding to the edge perpendicular component EC and is parallel to the pixel row (Step S1705).

Subsequently, the image processing apparatus 100 calculates the evaluation value v which represents the difference between the pixel value of the edge perpendicular component and the pixel value of the target pixel component TC for each of the target pixel components TC in the search range SR1 corresponding to the edge perpendicular component EC (Step S1706). The image processing apparatus 100 specifies the correction amount k for correcting the first motion vector V1 based on the evaluation value v of each of the target pixel components TC (Step S1707).

Subsequently, the image processing apparatus 100 corrects the first motion vector V1 based on the specified correction amount k (Step S1708). In addition, the image processing apparatus 100 determines whether or not there is an unselected target block TB which is not selected from the target frame TF (Step S1709).

In a case where there is an unselected target block TB (Yes in Step S1709), the image processing apparatus 100 returns to Step S1701. In contrast, in a case where there is no unselected target block TB (No in Step S1709), the image processing apparatus 100 ends a series of processes according to the flowchart, and returns to the step which calls the first motion vector correcting process. Accordingly, the first motion vector V1 obtained in the motion estimation of the reduced ME can be corrected.

<Specific Processing Procedure of Second Motion Vector Detecting Process>

Next, the specific processing procedure of the second motion vector detecting process of Step S1508 illustrated in FIG. 15 will be described.

FIG. 18 is a flowchart illustrating an example of the specific processing procedure of the second motion vector detecting process. In the flowchart of FIG. 18, first, the image processing apparatus 100 selects the target block TB from the target frame TF (Step S1801), and acquires the first motion vector V1 of the target block TB (Step S1802).

Subsequently, the image processing apparatus 100 determines whether or not the first motion vector V1 of the target block TB is corrected (Step S1803). Specifically, for example, in a case where the edge information Ej of the block Bj is specified based on the first motion vector V1 of the target block TB, the image processing apparatus 100 may determine that the first motion vector V1 is corrected.

Here, in a case where the first motion vector V1 is not corrected (No in Step S1803), the image processing apparatus 100 proceeds to Step S1805. In contrast, in a case where the first motion vector V1 is corrected (Yes in Step S1803), the image processing apparatus 100 sets the search range SR2 in the reference frame RF based on the first motion vector V1 after being corrected and the direction of the target pixel component TC (Step S1804).

Subsequently, the image processing apparatus 100 calculates the evaluation value v which represents the difference between the pixel value of the target block TB and the pixel value of the reference block RB for each of the reference blocks RB in the search range SR2 corresponding to the target block TB (Step S1805). In addition, the search range SR2 in the case where the first motion vector V1 is not corrected becomes the initial range.

The image processing apparatus 100 detects the second motion vector V2 of the target block TB based on the calculated evaluation value for each of the reference blocks RB (Step S1806). Subsequently, the image processing apparatus 100 determines whether or not there is an unselected target block TB which is not selected from the target frame TF (Step S1807).

In a case where there is an unselected target block TB (Yes in Step S1807), the image processing apparatus 100 returns to Step S1801. In contrast, in a case where there is no unselected target block TB (No in Step S1807), the image processing apparatus 100 ends a series of processes according to the flowchart, and returns to the step which calls the second motion vector detecting process.

Accordingly, in the search range SR2 which is set corresponding to the first motion vector V1 after being corrected, the second motion vector V2 of the target block TB can be searched.

(Example of Configuration of Encoding Apparatus 1900)

Next, an example of the configuration of an encoding apparatus 1900 to which the image processing apparatus 100 is applied will be described.

FIG. 19 is a block diagram illustrating the example of the configuration of the encoding apparatus 1900. In FIG. 19, the encoding apparatus 1900 includes an operating unit 1910 and a memory unit 1920. The operating unit 1910 includes an edge detecting unit 1911, an image reducing unit 1912, a reduced ME unit 1913, a reduced ME correcting unit 1914, an ME unit 1915, a DCT/quantizing unit 1916, an inverse DCT/inverse quantizing unit 1917, and an entropy encoding unit 1918. In addition, the memory unit 1920 includes a reduced original image buffer 1921, an edge information buffer 1922, an original image buffer 1923, and a reference image buffer 1924.

An input image which is input to the encoding apparatus 1900 is stored in the original image buffer 1923. The input image is an image which is a target to be compressed (encoding target). The edge detecting unit 1911 detects an edge of the input image. Edge information is stored in the edge information buffer 1922. The image reducing unit 1912 reduces the input image. Specifically, for example, the image reducing unit 1912 may create a reduced image of the input image through a low pass filter and resampling. The reduced image is stored in the reduced original image buffer 1921.

The reduced ME unit 1913 performs motion estimation using the reduced image stored in the reduced original image buffer 1921. In the motion estimation using the reduced image, although the accuracy is smaller than that of motion estimation using the original image, a search of a wide range can be performed with a small amount of operation. The reduced ME correcting unit 1914 corrects a motion vector obtained by the reduced ME unit 1913 by using the edge information stored in the edge information buffer 1922 and the original image stored in the original image buffer 1923.

The ME unit 1915 performs the motion estimation using the original image stored in the original image buffer 1923 and a reference image stored in the reference image buffer 1924. The ME unit 1915 reduces the amount of operation by reducing the search range of the motion estimation based on the motion vector after being corrected by the reduced ME correcting unit 1914.

The DCT/quantizing unit 1916 transforms a difference image into a frequency component and quantizes the resultant component. The inverse DCT/inverse quantizing unit 1917 performs a local decoding process to generate the reference image. The entropy encoding unit 1918 creates a bitstream by performing an entropy encoding process. The bitstream is a moving image bitstream output after being compressed.

Here, the original image stored in the original image buffer 1923 is used in the reduced ME correcting unit 1914 and the ME unit 1915. Therefore, the ME unit 1915 may not read the original image from the original image buffer 1923 but acquire the original image from the reduced ME correcting unit 1914. That is, by transmitting the original image data acquired by the reduced ME correcting unit 1914 between blocks, an effect of an increase in the transmission band of the original image data can be excluded.

In addition, the reduced reference image used in the reduced ME unit 1913 and the edge information used in the reduced ME correcting unit 1914 may be combined to be transmitted. Specifically, for example, the reduced ME unit 1913 may collectively read transmission information having the reduced reference image and the edge information combined, from the memory unit 1920.

In this case, the edge information is transmitted from the reduced ME unit 1913 to the reduced ME correcting unit 1914 through inter-block transmission between the reduced ME unit 1913 and the reduced ME correcting unit 1914. Here, a specific example of the transmission information which is collectively read from the memory unit 1920 will be described.

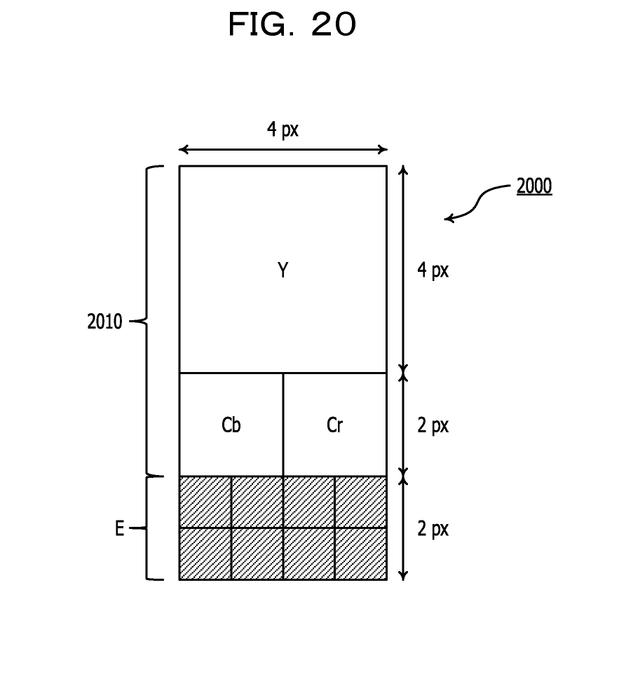

FIG. 20 is an explanatory view illustrating the specific example of the transmission information. In FIG. 20, transmission information 2000 is information including a reduced reference image 2010 for the block B (4×4 pixels) divided from the reduced image of the reference frame RF and the edge information E of the block B.

Here, the reduced reference image 2010 includes a 16-byte luminance signal (Y) of 4×4 pixels (px), a 4-byte color difference signal (Cb) of 2×2 pixels (px), and a 4-byte color difference signal (Cr) of 2×2 pixels (px) for the block B. That is, the reduced reference image 2010 becomes 24-byte information.

The edge information is 8-byte information including the direction information 501 (1 byte) and the pixel information 502 (7 bytes) as illustrated in FIG. 5. Therefore, the transmission information 2000 becomes 32-byte information (=256 bits). For example, in a case where the bit width of data transmission is 32 bytes, the transmission information 2000 can be transmitted at a time. Accordingly, the number of times of memory access for reading the edge information E used in the reduced ME correcting unit 1914 may not be increased.

In addition, the generating unit 702 of the image processing apparatus 100 corresponds to, for example, the edge detecting unit 1911. The creating unit 703 of the image processing apparatus 100 corresponds to, for example, the image reducing unit 1912. The first detecting unit 704 of the image processing apparatus 100 corresponds to the reduced ME unit 1913. The specifying unit 705, the first setting unit 706, the calculating unit 707, and the correcting unit 708 of the image processing apparatus 100 correspond to the reduced ME correcting unit 1914. The second setting unit 709 and the second detecting unit 710 of the image processing apparatus 100 correspond to the ME unit 1915. The memory 302 of the image processing apparatus 100 corresponds to the memory unit 1920.

As described above, according to the image processing apparatus 100 according to the embodiment, the edge perpendicular component EC of the block Bj in the reference frame RF may be specified based on the first motion vector V1 obtained in the reduced ME. According to the image processing apparatus 100, the search range SR1 which includes the pixel row in the target frame TF corresponding to the edge perpendicular component EC and is parallel to the pixel row may be set. According to the image processing apparatus 100, the evaluation value v which represents the difference between the pixel value of the edge perpendicular component EC and the pixel value of the target pixel component TC for each of the target pixel components TC in the search range SR1 corresponding to the edge perpendicular component EC may be calculated. According to the image processing apparatus 100, the first motion vector V1 may be corrected based on the evaluation value v of each of the target pixel components TC.

Accordingly, the position in a smaller unit than the reciprocal of the reduction ratio r may be obtained as the position in the reference frame RF indicated by the first motion vector V1. Specifically, the first motion vector V1 having a higher position accuracy than that before the correction in a direction parallel to the edge perpendicular component EC of the block Bj in the reference frame RF may be obtained.

According to the image processing apparatus 100, the search range SR2 may be set to the rectangular area in which the width in the direction parallel to the target pixel component TC is smaller than the width in the direction perpendicular to the target pixel component TC with respect to the point as the center in the reference frame RF indicated by the motion vector V1 after being corrected. Accordingly, the search range SR2 in the detailed ME may be set to the range which is further reduced than the initial range with respect to the direction parallel to the edge perpendicular component EC having high position accuracy in the reference frame RF.

According to the image processing apparatus 100, the evaluation value V which represents the difference between the pixel value of the target block TB and the pixel value of the reference block RB for each of the reference blocks RB in the search range SR2 corresponding to the target block TB may be calculated. According to the image processing apparatus 100, the second motion vector V2 of the target block TB may be detected based on the evaluation value V of each of the reference blocks RB.

Accordingly, the detailed ME can be performed in the limited range compared to the initial range, and the amount of operation for the motion estimation performed at high accuracy in units of pixels can be reduced.

Furthermore, according to the image processing apparatus 100, the edge perpendicular component EC of the block Bj, which is disposed at the position in the reference frame RF indicated by the first motion vector V1 and has the maximum degree of overlap with the target block TB, may be specified. Accordingly, a probability that block matching between the target block TB (the target pixel component TC) and the edge perpendicular component EC is performed may be increased.

The correction method described in this embodiment may be realized by executing a program which is prepared in advance on a computer such as a personal computer or a workstation. The correction program is recorded on a computer-readable recording medium such as a hard disk, a flexible disk, a CD-ROM, an MO, or a DVD and is executed by being read from the recoding medium by the computer. In addition, the correction program may be distributed via a network such as the Internet.

In addition, the image processing apparatus 100 described in this embodiment may be realized by an application-specific integrated circuit (hereinafter, referred to as “ASIC”) such as a standard cell or a structured ASIC or a programmable logic device (PLD) such as a FPGA. Specifically, for example, the above-described functions of the image processing apparatus 100 may be functionally defined by an HDL description, and the HDL description may be logically synthesized and imparted to the ASIC or PLD to manufacture the image processing apparatus 100.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An image processing apparatus comprising:
a memory; and
a processor coupled to the memory and configured to:
detect, based on a reduced image of a target frame and a reduced image of a reference frame, a first motion vector of a target block divided from the target frame,
set a search range including a pixel row in the target frame and parallel to the pixel row corresponding to a first pixel component that is specified by the first motion vector and substantially perpendicular to an edge direction of a block in the reference frame,
calculate, for each of second pixel components corresponding to the first pixel component in the search range, an evaluation value representing a difference of a pixel value between the first pixel component and the second pixel component, and
correct the first motion vector based on the evaluation value of each of the second pixel components.

2. The image processing apparatus according to claim 1,
wherein the processor is configured to:
set a second search range in the reference frame based on the corrected first motion vector and a direction of the second pixel component,
calculate, for each of reference blocks in the second search range corresponding to the target block, an evaluation value which represents a difference of a pixel value between the target block and the reference block in the second search range, and
detect a second motion vector of the target block based on the evaluation value of each of the reference blocks.

3. The image processing apparatus according to claim 2,
wherein the processor is configured to set the second search range to a rectangular area in which a width in a direction parallel to the second pixel component is smaller than a width in a direction perpendicular to the second pixel component with respect to a point as a center in the reference frame indicated by the corrected first motion vector.

4. The image processing apparatus according to claim 1,
wherein the processor is configured to specify the first pixel component based on a degree of overlap with the target block disposed at a position in the reference frame indicated by the first motion vector and the block in the reference frame.

5. The image processing apparatus according to claim 4,
wherein the processor is configured to:
generate, for each of blocks divided from the reference frame, by detecting an edge of the block, edge information including direction information indicating an edge direction of the block and a pixel value of a pixel component substantially perpendicular to the edge direction,
specify, with reference to the edge information of each of the blocks, a pixel component substantially perpendicular to the edge direction of the block having the maximum degree of overlap between the target block disposed at a position in the reference frame indicated by the first motion vector and a pixel component substantially perpendicular to the edge direction of the block in the reference frame as the first pixel component, and
calculate the evaluation value, based on the edge information including the pixel value of the first pixel component.

6. The image processing apparatus according to claim 1,
wherein the evaluation value is a sum of absolute difference (SAD), a sum of absolute transformed difference (SATD), or a sum of squared difference (SSD).

7. A image processing method comprising:
detecting, based on a reduced image of a target frame and a reduced image of a reference frame, a first motion vector of a target block divided from the target frame;
setting a search range including a pixel row in the target frame and parallel to the pixel row corresponding to a first pixel component that is specified by the first motion vector and substantially perpendicular to an edge direction of a block in the reference frame;
calculating, for each of second pixel components corresponding to the first pixel component in the search range, an evaluation value representing a difference of a pixel value between the first pixel component and the second pixel component; and
correcting, by a processor, the first motion vector based on the evaluation value of each of the second pixel components.

8. A computer-readable recoding medium having a correction program recorded thereon to cause a computer to execute processes of:
detecting, based on a reduced image of a target frame and a reduced image of a reference frame, a first motion vector of a target block divided from the target frame;
setting a search range including a pixel row in the target frame and parallel to the pixel row corresponding to a first pixel component that is specified by the first motion vector and substantially perpendicular to an edge direction of a block in the reference frame;
calculating, for each of second pixel components corresponding to the first pixel component in the search range, an evaluation value representing a difference of a pixel value between the first pixel component and the second pixel component; and
correcting the first motion vector based on the evaluation value of each of the second pixel components.
